(19) United States
(12) Patent Application Publication
(10) Pub. No.: US 2025/0236198 A1
(43) Pub. Date: Jul. 24, 2025

(54) SMART CHARGING RECOMMENDATIONS FOR ELECTRIC VEHICLES

(71) Applicant: OLA ELECTRIC MOBILITY LIMITED, Bangalore (IN)

(72) Inventors: Hitesh HINDUJA, Bangalore (IN); Gaurav AGARWAL, Bengaluru (IN)

(21) Appl. No.: 18/699,262

(22) PCT Filed: Oct. 7, 2022
(86) PCT No.: PCT/IN2022/050903

§ 371 Date: Apr. 5, 2024

(30) Foreign Application Priority Data
Oct. 8, 2021 (IN) 202141045911

(51) Int. Cl. B60L 53/62; B60L 53/66; B60L 58/12

(52) U.S. Cl. CPC B60L 53/62; B60L 53/665; B60L 58/12; B60L 2240/622; B60L 2260/44; B60L 2260/52; B60L 2260/54

(57) ABSTRACT

A vehicle including an energy storage device and processing circuitry. The processing circuitry detects a charging session being initiated to charge the energy storage device. The processing circuitry further obtains a current state of charge (SoC) associated with the energy storage device and first vehicle usage information that indicates a usage of the vehicle over a historical time-interval. The processing circuitry further predicts vehicle usage over a first time-interval based on the obtained first vehicle usage information and rate the charging session at current time-instance based on the predicted vehicle usage and the current SoC. The processing circuitry further generates an alternate charging plan based on the charging session at the current time-instance being rated suboptimal and outputs the generated alternate charging plan at the current time-instance.

### BACKGROUND

### Technical Field

Various embodiments of the disclosure relate generally to vehicles. More specifically, various embodiments of the disclosure relate to vehicles, systems, and methods for providing charging recommendations for charging electric vehicles.

### Description of the Related Art

Transportation constitutes an important aspect of the modern world. Modern-day vehicles include internal combustion engine (ICE) vehicles, electric vehicles (EVs), and hybrid vehicles. However, sales of EVs have been on an upward trajectory in recent years, and, EVs are expected to supplant ICE vehicles as the main mode of personal transport in the near future. An EV primarily includes a rechargeable battery pack (e.g., a lithium-ion battery pack, a lead-acid battery pack, or the like) and an electric motor (e.g., an alternating current induction motor). Wheels of the EV are driven by the electric motor that draws power from the battery pack. The battery pack also supplies power to other vehicular systems in the EV such as an air-conditioner, a music system, or the like. Once the battery pack has discharged, the battery pack is to be recharged or swapped with another battery pack so that the EV could be driven again.

Typically, EV owners charge their EVs as per convenience or availability of charging infrastructure. However, such an approach for charging EVs may not be efficient in terms of charging costs, battery health, usability, or the like. For example, an owner of an EV, who daily uses their EV to commute between home and office, may charge the EV for an entire night so as to ensure that the EV is fully charged when the owner has to leave for office the next day. However, such charging of the EV may degrade battery health of the EV and may negatively impact remaining useful life of the battery pack. In another example, in order to curb range anxiety issues, the owner may daily charge the EV to 100% at their office even when the EV has sufficient electric charge to accommodate commuting requirements for the next two to three days. Therefore, the owners of the EVs might be unknowingly damaging their EVs and incurring suboptimal charging costs.

In light of the foregoing, there exists a need for a technical and reliable solution that overcomes the abovementioned problems, and facilitates optimal charging of EVs.

Limitations and disadvantages of conventional and traditional approaches will become apparent to one of skill in the art, through comparison of described systems with some aspects of the present disclosure, as set forth in the remainder of the present application and with reference to the drawings.

### BRIEF SUMMARY

Systems and methods for providing charging recommendations for charging electric vehicles are provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

Certain embodiments of the disclosure may be found in disclosed vehicle and methods for providing charging recommendations for charging batteries of the vehicle. Exemplary aspects of the disclosure provide methods for providing charging recommendations for charging batteries of vehicles. The methods include various operations that are executed by processing circuitry to provide charging recommendations for charging a vehicle (for example, a battery or battery pack of an electric vehicle). In some embodiments, the processing circuitry may be configured to detect, at a current time-instance, a charging session being initiated to charge an energy storage device configured to power the vehicle. The processing circuitry may be further configured to obtain a current state of charge (SoC) associated with the energy storage device of the vehicle and first vehicle usage information that indicates a usage of the vehicle over a historical time-interval. The historical time-interval occurs prior to the current time-instance. The processing circuitry may be further configured to predict vehicle usage over a first time-interval based on the obtained first vehicle usage information. The first time-interval occurs after the current time-instance. The processing circuitry may be further configured to rate the charging session at the current time-instance based on the predicted vehicle usage and the current SoC. The processing circuitry may be further configured to generate an alternate charging plan based on the charging session at the current time-instance being rated suboptimal. The generated alternate charging plan is rated optimal and accommodates the predicted vehicle usage. The processing circuitry may be further configured to output the generated alternate charging plan at the current time-instance.

In some embodiments, the vehicle usage over the first time-interval may be predicted by a neural network that has learnt a vehicle usage pattern for the vehicle based on time-series of vehicle usage data of the vehicle.

In some embodiments, the processing circuitry may be further configured to execute a comparative analysis of an actual charging log and a recommended charging log associated with the vehicle. The actual charging log indicates an actual charging history of the vehicle. The recommended charging log indicates a charging history in accordance with the alternate charging plan. In some embodiments, the actual charging log may be same as the recommended charging log. In some embodiments, the actual charging log may be different from the recommended charging log.

In some embodiments, the alternate charging plan may include at least one of an alternate location to charge, an alternate charging speed, an alternate cost of charging, an alternate time-instance to charge, and an alternate SoC of the energy storage device that may be different from the current SoC to initiate an alternate charging session of the energy storage device.

In some embodiments, the processing circuitry may be further configured to receive, via a user device associated with the vehicle, a user input to modify the alternate charging plan. The processing circuitry may be further configured to regenerate a new alternate charging plan based on the received user input. The processing circuitry may be further configured to output the new alternate charging plan at the current time-instance.

In some embodiments, the processing circuitry may be further configured to rate the current charging session based on at least one of one or more driving parameters associated with the predicted vehicle usage of the vehicle, a cost of charging during the current charging session, a charging time duration required for the current charging session, and an impact of the current charging session on a state of health (SoH) of the energy storage device. In some embodiments, the energy storage device may be one of a battery, a supercapacitor, and a battery pack.

In some embodiments, the predicted vehicle usage information may include at least one of one or more routes to be traveled by the vehicle, a time of travel corresponding to each route to be traveled by the vehicle, one or more driving parameters, a count of drivers of the vehicle, a count of riders of the vehicle, and auxiliary power consumption by one or more vehicle accessories during one or more trips by the vehicle, over the first time-interval.

In some embodiments, the one or more driving parameters may include a velocity profile, a braking profile, an acceleration profile, and a mode of operating the vehicle over the first time-interval.

In some embodiments, the processing circuitry may be further configured to obtain a current SoC associated with the energy storage device of the vehicle at a second time-instance and second vehicle usage information that indicates a usage of the vehicle prior to the second time-instance. The processing circuitry may be further configured to predict vehicle usage over a second time-interval based on the obtained second vehicle usage information. The second time-interval occurs after the second time-instance. The processing circuitry may be further configured to generate a recommended charging plan for the energy storage device based on the current SoC at the second time-instance being insufficient to accommodate the predicted vehicle usage over the second time-interval. The processing circuitry may be further configured to output the recommended charging plan at the second time-instance.

In some embodiments, the recommended charging plan may include one of a recommended location to charge the energy storage device, a recommended charging duration to charge the energy storage device, a recommended SoC to be attained by charging the energy storage device, a route to be traversed to reach the recommended charging location to charge the energy storage device, and a recommended auxiliary power consumption of the vehicle while traversing the route to reach the recommended charging location.

The vehicle, methods and systems of the disclosure provide a solution for generating charging plans for charging an energy storage device of the vehicle. The vehicle, methods, and systems disclosed herein allows a user associated with the vehicle to keep the energy storage device of the vehicle charged enough to accommodate vehicle usage associated with the vehicle. Hence, the disclosed vehicle, methods, and systems provide a solution to alleviate range anxiety of the user of the vehicle. Further, the disclosed vehicle, methods, and systems are artificial intelligence (AI) enabled so as to make decisions based on whether there is a requirement to charge the energy storage device to accommodate subsequent usage of the vehicle and availability of charging opportunities to charge the energy storage device. Therefore, a probability of the vehicle to get stranded due to insufficient charging of the energy storage device significantly reduces.

### BRIEF DESCRIPTION OF THE SEVERAL VIEWS OF THE DRAWINGS

FIG. 1A is a block diagram that illustrates a system environment for implementation of a charging recommendation method, in accordance with an exemplary embodiment of the disclosure;

FIG. 1B is another block diagram that illustrates another system environment for implementation of the charging recommendation method, in accordance with another exemplary embodiment of the disclosure;

FIG. 2 is a block diagram of a vehicle, in accordance with an exemplary embodiment of the disclosure;

FIG. 3 is a schematic diagram that illustrates an exemplary environment for training a neural network, in accordance with an exemplary embodiment of the disclosure;

FIG. 4A is a schematic diagram that illustrates an exemplary environment for generating an alternate charging plan for the vehicle, in accordance with an exemplary embodiment of the disclosure;

FIG. 4B is another schematic diagram that illustrates another exemplary environment for generating the alternate charging plan for the vehicle, in accordance with an exemplary embodiment of the disclosure;

FIG. 5 is a schematic diagram that illustrates an exemplary environment for implementing the charging recommendation method, in accordance with an exemplary embodiment of the disclosure;

FIGS. 6A and 6B are schematic diagrams that, collectively, illustrate exemplary scenarios for presenting charging plans, in accordance with an exemplary embodiment of the disclosure;

FIG. 7 is a block diagram that illustrates a system architecture of a computer system for implementation of the charging recommendation method, in accordance with an exemplary embodiment of the disclosure;

FIG. 8 is a flowchart that illustrates the charging recommendation method, in accordance with an exemplary embodiment of the disclosure;

FIGS. 9A and 9B, collectively, represent a high-level flowchart that illustrates the charging recommendation method, in accordance with an exemplary embodiment of the disclosure; and

FIG. 10 is a flowchart that illustrates the charging recommendation method, in accordance with an exemplary embodiment of the disclosure.

### DETAILED DESCRIPTION

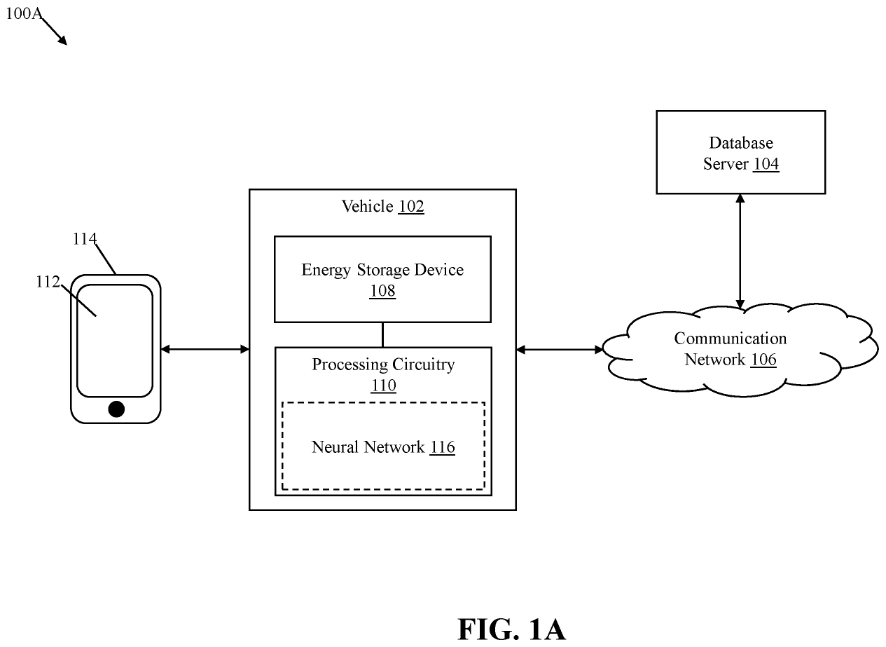

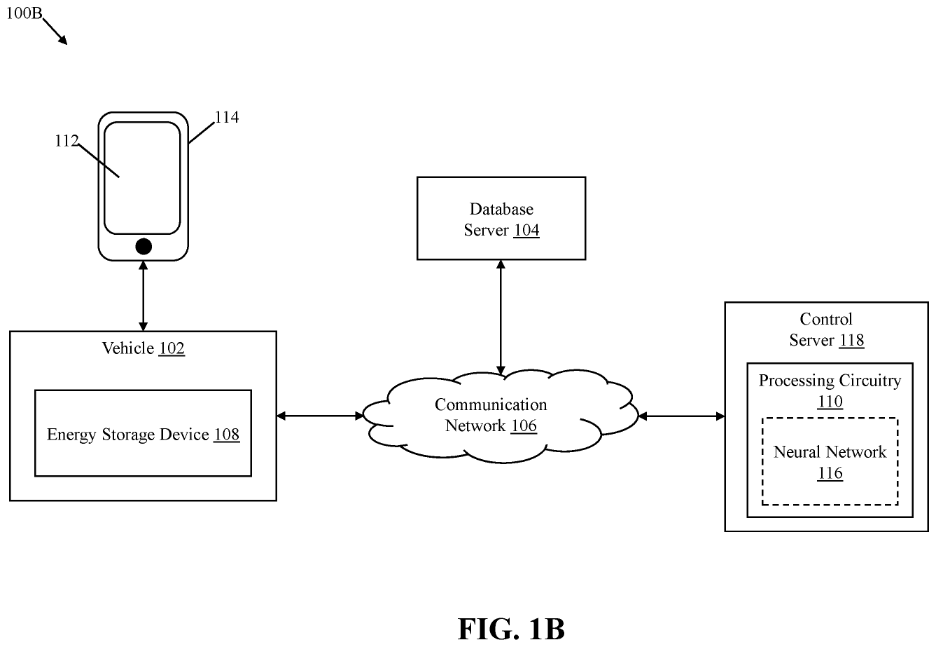

FIG. 1A is a block diagram that illustrates a system environment for implementation of a charging recommendation method, in accordance with an exemplary embodiment of the disclosure. Referring to FIG. 1A, the system environment 100A includes a vehicle 102, a database server 104, and a communication network 106. The vehicle 102 includes an energy storage device 108 and processing circuitry 110. The vehicle 102 may be communicatively coupled to the database server 104 via the communication network 106. Examples of the communication network 106 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities (such as the vehicle 102 and the database server 104) in the system environment 100A may be coupled to the communication network 106 in accordance with various wired and wireless communication protocols, such as Transmission Control Protocol and Internet Protocol (TCP/IP), User Datagram Protocol (UDP), Long Term Evolution (LTE) communication protocols, or any combination thereof.

The vehicle 102 is a mode of transport and may include suitable logic, circuitry, interfaces, and/or code, executable by the circuitry, that may be configured to control and perform one or more operations with or without any driving assistance. In some embodiments, the vehicle 102 may be an electric vehicle, a hybrid vehicle, or the like. In some embodiments, the vehicle 102 may be associated with a transportation service provider (e.g., a cab service provider, an on-demand transportation service provider, or the like) to cater to traveling requirements of various passengers. In some embodiments, the vehicle 102 may be privately owned by corresponding driver and may be used for fulfilling self-traveling requirements. Examples of the vehicle 102 may include, but are not limited to, an automobile, a bus, a car, an auto-rickshaw, a scooter, and a bike. In some embodiments, the vehicle 102 may be a two-wheeled vehicle, a three-wheeled vehicle, or a four-wheeled vehicle.

Further, the vehicle 102 or one or more components of the vehicle 102 may be powered by the energy storage device 108. The energy storage device 108 may be configured to provide electric charge required for operating the vehicle 102. The energy storage device 108 may be one of a battery, a battery pack, a supercapacitor, an ultracapacitor, or the like. The energy storage device 108 may be configured to store the electric charge that may be provided to the vehicle 102 for its operations. As a result, the electric charge stored in the energy storage device 108 gets drained. Hence, the energy storage device 108 may require to be charged or replaced periodically. In order to charge the energy storage device 108 charging sessions may be initiated by a user of the vehicle 102. In a charging session, the energy storage device 108 may be coupled to a power source, for example, an AC power source or a DC power source. The energy storage device 108 may be coupled to the power source in a wired manner or a wireless manner. Based on coupling between the energy storage device 108 and the power source, the energy storage device 108 may be configured to receive electric charge that may be stored in the energy storage device 108 to power the vehicle 102. The charging sessions may be initiated by the user based on their convenience.

The energy storage device 108 may include suitable logic, circuitry, interfaces, and/or code, executable by the circuitry, that may be configured to power the one or more components (e.g., engine, lights, indicator, human machine interface, or the like) of the vehicle 102. Examples of the energy storage device 108 may include, but are not limited to, lithium-ion batteries, nickel-metal hydride batteries, lead-acid batteries, ultracapacitors, or the like. In one embodiment, the energy storage device 108 may include a set of battery packs that include a single type of battery (e.g., lithium-ion batteries, nickel-metal hydride batteries, or the like). In another embodiment, the energy storage device 108 may include a set of battery packs that include different types of batteries (e.g., a combination of lithium-ion batteries and nickel-metal hydride batteries). In another embodiment, the energy storage device 108 may include different batteries or battery packs for different vehicular sub-systems in the vehicle 102. For example, one battery pack included in the energy storage device 108 may be configured to provide power to an electric motor of the vehicle 102. Similarly, another battery pack included in the energy storage device 108 may be configured to provide power to lighting system of the vehicle 102. Once the energy storage device 108 has been discharged, it may have to be recharged so that the vehicle 102 may be driven again.

The processing circuitry 110 may include suitable logic, circuitry, interfaces, and/or code, executable by the circuitry, that may be configured to perform one or more operations for generating charging plans (e.g., alternate charging plans, recommended charging plans, or the like) for charging the vehicle 102. The processing circuitry 110 may be configured to perform various operations associated with data collection and data processing. The processing circuitry 110 may be implemented by one or more processors, such as, but not limited to, an application-specific integrated circuit (ASIC) processor, a reduced instruction set computing (RISC) processor, a complex instruction set computing (CISC) processor, and a field-programmable gate array (FPGA) processor. The one or more processors may also correspond to central processing units (CPUs), graphics processing units (GPUs), network processing units (NPUs), digital signal processors (DSPs), or the like. It will be apparent to a person of ordinary skill in the art that the processing circuitry 110 may be compatible with multiple operating systems. As shown in FIG. 1A, the processing circuitry 110 may be included in the vehicle 102 and may be internal to the vehicle 102. The processing circuitry 110 may be configured to operate in two phases, i.e., a training phase and an implementation phase. During the training phase, the processing circuitry 110 may be configured to train a neural network 116 to learn a vehicle usage pattern and a charging pattern of the vehicle 102. During the implementation phase, the processing circuitry 110 may be configured to utilize the trained neural network 116 to generate smart charging recommendations for the vehicle 102.

The database server 104 may include suitable logic, circuitry, interfaces, and/or code, executable by the circuitry, that may be configured to perform one or more operations for collecting and storing data associated with the vehicle 102. For example, the database server 104 may collect and store data pertaining to a use of the vehicle 102 and charging the energy storage device 108, routes traveled by the vehicle 102, parking locations of the vehicle 102, users of the vehicle 102, maintenance and repair data of the vehicle 102, or the like. The database server 104 may obtain the aforementioned data from one of a driver device of the vehicle 102, the user device 114 associated with the vehicle 102, a maintenance database of the vehicle 102 maintained by a maintenance center associated with the vehicle 102, or the like. Examples of the database server 104 may include a cloud-based database, a local database, a distributed database, a database management system (DBMS), or the like. The database server 104 may be accessible to the processing circuitry 110 via the communication network 106. In another embodiment, the data stored by the database server 104 may be stored locally in a memory of the vehicle 102.

In operation, the processing circuitry 110 may be configured to implement the training phase for a defined time interval, for example, a training time-interval. The training time-interval may refer to a training period for training the neural network 116. Examples of the training time-interval may include one day, two days, one week, two weeks, one month, six months, or the like. In an example, the training time-interval may begin from a first use time instance of the vehicle 102 (for example, when the vehicle 102 is used for the first time by a new user). During the training phase, the processing circuitry 110 may be configured to receive (or collect) time-series of vehicle usage data of the vehicle 102 and a charging log of the vehicle 102.

The time-series of vehicle usage data may include data that indicates vehicle usage in a chronological order over the training time-interval. For example, the time-series of vehicle usage data may indicate that on Day 1, the vehicle 102 was used to commute from home to office of the user of the vehicle 102 at 10 AM and from office to home at 6 PM. The time-series of vehicle usage data of Day 1 may further indicate details (for example, distance travelled, acceleration profile, braking profile, state of charge (SoC) of the energy storage device 108, pattern of use of one or more vehicle accessories, routes travelled, time of journey, count of passengers on the vehicle 102, or the like) pertaining to the commute of Day 1. Similarly, the time-series of vehicle usage may include data pertaining to various vehicle usage instances over the training time-interval.

The charging log may indicate a timestamped list of various charging sessions initiated during the training time-interval to charge the energy storage device 108. For each charging session, the charging log may include data pertaining to an initial SoC and attained SoC of the energy storage device 108. The initial SoC may refer to electric charge available with the energy storage device 108 prior to initiation of a charging session. The attained SoC may refer to electric charge available with the energy storage device 108 after a charging session is terminated. For each charging session, the charging log may further include details of a charging location where the corresponding charging session was initiated, a cost of charging at the charging location, a type of charging (for example, slow charging or fast charging), a state of health (SoH) of the energy storage device 108 at the end of every charging session, a time of charging, or the like.

The processing circuitry 110 may receive the time-series of vehicle usage data and the charging log from the database server 104 (or local memory). Based on the received time-series of vehicle usage data and the charging log, the processing circuitry 110 may be configured to train the neural network 116. In some embodiments, training of the neural network 116 may be a continuous process during the training phase. For example, on Day 1, the processing circuitry 110 may be configured to provide the time-series of vehicle usage data and the charging log of Day 1 as input to the neural network 116 to train the neural network 116. On Day 2, the processing circuitry 110 may be configured to provide the time-series of vehicle usage data and the charging log of Day 2 as input the neural network 116 to further train the neural network 116. Thus, by end of Day 2, the neural network 116 successfully learns the vehicle usage pattern and the charging pattern of the vehicle 102 for two days, Day 1 and Day 2.

The vehicle usage pattern may refer to a trend of using the vehicle 102. For example, the vehicle 102 may be driven from “a home location” to “an office location” from “Monday” to “Friday” at 9 AM. Therefore, based on the time-series of vehicle usage data, the neural network 116 may learn a usage pattern that the vehicle 102 is used by the user to commute from “the home location” to “the office location” every “Monday” to “Friday” at 9 AM. The learnt usage pattern of the vehicle 102 may further indicate details such as distance travelled, acceleration profile, braking profile, SoC consumed, pattern of use of one or more vehicle accessories, routes travelled, duration of journey, count of passengers on the vehicle 102, or the like for the trip from home to office. In another example, based on the time-series of vehicle usage data, the neural network 116 may learn that the vehicle 102 is driven by the user for a road trip of “30 kilometers (kms)” on every “Saturday” and the road trip starts at 9 AM.

The charging pattern may refer to a pattern of charging the energy storage device 108. The charging pattern may indicate an initial SoC range in which charging sessions of the energy storage device 108 are initiated, one or more locations where the energy storage device 108 is charged, time instances at which corresponding charging sessions are initiated, a time-duration for which corresponding charging session lasts, or the like. In an example, every “Friday” at 10 PM, a charging session may be initiated for charging the energy storage device 108 at user's home and the charging session may last until the energy storage device 108 is charged to 100%. Thus, based on the charging log of the vehicle 102, the neural network 116 may learn that the vehicle 102 is charged to 100% every “Friday” at 10 PM.

The neural network 116 may be further configured to learn an impact of the charging sessions on the SoH of the energy storage device 108. For example, if the SoH of the energy storage device 108 decreases after a first charging session, the neural network 116 may learn that various charging parameters (such as type of charging, duration of charging, initial SoC, attained SoC, or the like) at the first charging session have negative impact on the SoH of the energy storage device 108. However, if the SoH of the energy storage device 108 increases or remains same after a second charging session, the neural network 116 may learn that various charging parameters at the second charging session have positive impact on the SoH of the energy storage device 108. In other words, the neural network 116 may be trained to learn a relationship between charging and SoH of the energy storage device 108.

The neural network 116 may be further configured to learn various charging opportunities available for the vehicle 102 based on the learnt charging pattern and the vehicle usage pattern of the vehicle 102. For example, the learnt vehicle usage pattern may indicate that the vehicle 102 is parked in an office parking space from 10 AM to 6 PM and in a home parking space between 10 PM to 9 AM on weekdays (e.g., Monday to Friday). Further, the learnt charging pattern may indicate that the energy storage device 108 is charged while the vehicle 102 is parked in the office parking space and the home parking space. Thus, the neural network 116 may further learn that charging opportunities for the vehicle 102 are available when the vehicle 102 is parked in the office parking space or the home parking space.

The training of the neural network 116 may continue until a desired level of accuracy is achieved for the neural network 116. Upon successful charging of the vehicle 102 by the trained neural network 116, the processing circuitry 110 may execute the implementation phase.

During the implementation phase, the energy storage device 108 of the vehicle 102 may be coupled to a power source to charge the energy storage device 108. The processing circuitry 110 may be configured to detect that a charging session is initiated to charge the energy storage device 108 when the processing circuitry 110 detects that the energy storage device 108 is coupled to the power source. The processing circuitry 110 may detect the charging session being initiated based on a change in status of the energy storage device 108 from “not charging” to “charging.” The processing circuitry 110 may monitor the status of the energy storage device 108 continuously, periodically, or when prompted via the user device 114. The processing circuitry 110 may be configured to obtain a current state of charge (SoC) of the energy storage device 108 at a current time-instance (e.g., a first time-instance) when the charging session is initiated. The current SoC may refer to an amount of electric charge available with the energy storage device 108 when the charging session is initiated. The current SoC may be obtained by the processing circuitry 110 from one or more components (e.g., the energy storage device 108, telematics device, on-board diagnostic device, or the like) of the vehicle 102. The processing circuitry 110 may be further configured to obtain first vehicle usage information that indicates usage of the vehicle 102 over a historical time-interval prior to the current time-instance. The first vehicle usage information may be obtained from one of the telematics device, a human machine interface of the vehicle 102, the database server 104, or the local memory of the vehicle 102, or the like. The first vehicle usage information may be indicative of information regarding use of vehicle before the detected charging session.

The processing circuitry 110 may be further configured to predict vehicle usage of the vehicle 102 over a first time-interval based on the obtained first vehicle usage information. For example, the processing circuitry 110 may provide the obtained first vehicle usage information as input to the neural network 116, and the neural network 116 may predict the vehicle usage for the first time-interval as output. The first time-interval occurs after the current time-instance and may refer to a time-duration for which the current SoC of the energy storage device 108 at the current time-instance is expected/predicted to last. For example, the current SoC of the energy storage device 108 may be 50% which is expected or predicted to last for two hours. In such a scenario, the processing circuitry 110 may be configured to predict the vehicle usage of the vehicle 102 for the next two hours from the current time-instance. Thus, the first time-interval for which the vehicle usage of the vehicle 102 is predicted by the processing circuitry 110 is dynamic in nature and may vary as per the current SoC of the energy storage device 108. The predicted vehicle usage may be indicative of use of the vehicle 102 during the first time-interval. The predicted vehicle usage may include at least one of one or more routes to be traveled by the vehicle 102, a time of travel corresponding to each route to be traveled by the vehicle 102, one or more driving parameters, a count of drivers of the vehicle 102, a count of riders of the vehicle 102, and auxiliary power consumption by one or more vehicle accessories during one or more trips by the vehicle 102, over the first time-interval.

The processing circuitry 110 may be further configured to identify one or more charging opportunities that may be available in the first time-interval for charging the vehicle 102 based on the predicted vehicle usage. For example, the vehicle 102 may be predicted to be parked at the office location for 30 minutes in the first time-interval and the learnt charging pattern may indicate that the vehicle 102 had been charged at the office location in the past. In such a scenario, the processing circuitry 110 by using the neural network 116 may identify 30 minutes of parking time at the office location as one of the charging opportunities in the first time-interval. In another example, the vehicle 102 may be predicted to be parked in the parking area of a restaurant for 15 minutes in the first time-interval and a geographical location of the parking area of the restaurant may indicate presence of one or more charging stations for charging the vehicle 102. In such a scenario, the processing circuitry 110 may identify 15 minutes of parking time in the parking area of the restaurant as one of the charging opportunities in the first time-interval.

The processing circuitry 110 may be further configured to rate the charging session initiated at the current time-instance and one or more charging sessions that could be initiated at the identified charging opportunities based on the predicted vehicle usage. The processing circuitry 110 may be further configured to generate an alternate charging plan based on the charging session initiated at the current time-instance being rated suboptimal. Here, the generated alternate charging plan may correspond to one of the identified charging opportunities in the first time-interval and may have been rated optimal by the processing circuitry 110. In an example, the charging session initiated at the current time-instance may be rated suboptimal as compared to the generated alternate charging plan based on, for example, one of one or more driving parameters associated with the predicted vehicle usage of the vehicle 102, a cost of charging during the current charging session, a charging time duration required for the current charging session, an impact of the current charging session on a state of health (SoH) of the energy storage device 108, and/or a type of charging (such as slow charging or fast charging) of the current charging session. The one or more driving parameters may include a velocity profile, a braking profile, an acceleration profile, and a mode of operating the vehicle 102 over the first time-interval.

In an example, the charging session initiated at the current time-instance may be rated as 2 by the processing circuitry 110. The current time-instance may be rated 2 as the energy storage device 108 may be fully charged and the charging session may negatively impact the SoH of the energy storage device 108. The processing circuitry 110 may determine that a subsequent charging opportunity may be after 4 hours. Based on predicted vehicle usage, the processing circuitry 110 may predict that charging status at the subsequent charging opportunity may be 30%. Hence, the subsequent charging opportunity may be rated 1. Therefore, the detected charging session may be suboptimal and the subsequent charging opportunity may be optimal for charging the energy storage device 108.

The alternate charging plan may be generated by the processing circuitry 110 in a way that it accommodates the predicted vehicle usage in the first time-interval without causing the energy storage device 108 to be completely drained of energy. In some embodiments, the alternate charging plan may include an alternate location to charge, an alternate charging speed, an alternate cost of charging, an alternate time-instance to charge, and an alternate SoC associated with the energy storage device 108 that may be different from the current SoC at the current time-instance to initiate an alternate charging session.

The processing circuitry 110 may be configured to output the generated alternate charging plan at the current time-instance to be presented to the user of the vehicle 102 as an alternative to the detected current charging session. In some embodiments, the processing circuitry 110 may be configured to output the alternate charging plan by way of a user interface 112 of a user device 114 associated with the vehicle 102. The user device 114 may be a driver device (e.g., a cellphone, a wearable computing device, the human machine interface (HMI) of the vehicle 102, or the like) associated with the user of the vehicle 102. In some embodiments, the user device 114 may be external to the vehicle 102. In another embodiment, the user device 114 may be integral to the vehicle 102, for example, an HMI of the vehicle 102.

In some embodiments, the processing circuitry 110 may be further configured to receive, via the user device 114 associated with the vehicle 102, a user input to modify the alternate charging plan. The processing circuitry 110 may be further configured to regenerate a new alternate charging plan based on the received user input. The processing circuitry 110 may be further configured to output the new alternate charging plan at the current time-instance.

In some embodiments, the processing circuitry 110 may be further configured to obtain a current SoC of the energy storage device 108 at a second time-instance and second vehicle usage information that indicates usage of the vehicle 102 prior to the second time-instance. The second time-instance may be prior to the first time-instance or after the first time-instance. The current SoC at the second time-instance may be obtained by the processing circuitry 110 periodically, or when prompted by the user device 114 associated with the vehicle 102. The processing circuitry 110 may be further configured to predict vehicle usage over a second time-interval based on the obtained second vehicle usage information. The second time-interval occurs after the second time-instance and may refer to a time-duration for example, between the second time-instance and a subsequent predicted charging session of the energy storage device 108 after the second time-instance. The processing circuitry 110 may be further configured to generate a recommended charging plan for the energy storage device 108 based on the current SoC at the second time-instance being insufficient to accommodate the predicted vehicle usage over the second time-interval. The recommended charging plan may include one of a recommended location to charge the energy storage device 108, a recommended charging duration to charge the energy storage device 108, a recommended SoC to be attained by charging the energy storage device 108, a route to be traversed to reach the recommended charging location to charge the energy storage device 108, and a recommended auxiliary power consumption of the vehicle 102 while traversing the route to reach the recommended charging location.

In an example, the SoC of the energy storage device 108 may be 10% at 4 PM on a Wednesday while the vehicle 102 is parked in the office parking space as indicated by the second vehicle usage information. The learnt charging pattern may indicate that the vehicle 102 will be put to charging at 10 PM once the vehicle 102 is parked at the home parking location. In such a scenario, the processing circuitry 110 may predict the vehicle usage over from 4 PM to 10 PM (e.g., the second time-interval) based on the obtained second vehicle usage information. The vehicle usage over the second time-interval may be predicted by using the trained neural network 116. As the processing circuitry 110 determines that the SoC of the energy storage device 108 is 10% which is insufficient to reach from office to home (e.g., to accommodate the predicted vehicle usage over the second time-interval), the processing circuitry 110 may determine available charging opportunities during the second time-interval and generate a recommended charging plan to charge the vehicle 102 using the available charging opportunities. The processing circuitry 110 may select a most optimal charging opportunity for charging the vehicle 102 among the identified available charging opportunities and generate the recommended charging plan according to the most optimal charging opportunity. If the office parking space has a charging station (e.g., an available charging opportunity), the processing circuitry 110 may generate the recommended charging plan to charge the vehicle 102 using the charging station at the office parking space to at least attain 25% SoC so that the vehicle 102 may reach from office to home without getting stranded due to lack of energy. However, if the office parking space has no charging station, the processing circuitry 110 may generate the recommended charging plan to charge the vehicle 102 using a public charging station (another charging opportunity) that is reachable from the office parking space without exhausting the available 10% SoC of the energy storage device 108. In such a scenario, the recommended charging plan may further include a recommended charging duration to charge the energy storage device 108, a recommended SoC to be attained by charging the energy storage device 108, a route to be traversed to reach the recommended public charging station from office, and a recommended auxiliary power consumption of the vehicle 102 while traversing the route to reach the recommended public charging station.

In another example, the current SoC at the second time-instance detected by the processing circuitry 110 may be “40%” at 11 AM on a Saturday. The second vehicle usage information may indicate that the vehicle 102 is currently being driven from home to a Golf Club and the learnt charging pattern may indicate that the vehicle 102 will be put to charging at 2 PM once the vehicle 102 reaches back home and is parked at the home parking location. Thus, the processing circuitry 110 may predict the vehicle usage over from 11 AM to 2 PM (e.g., the second time-interval) based on the obtained second vehicle usage information. Based on the second vehicle usage information and the learnt vehicle usage pattern, the processing circuitry 110 may predict that the vehicle 102 will reach the Golf Club at 12 PM, will be parked at the Golf Club for 1 hour, subsequently the vehicle 102 will be driven to a restaurant from the Golf Club at 1 PM, and after being parked for 30 minutes at the restaurant parking the vehicle 102 will be driven to the home location from the restaurant at 1:30 PM. The processing circuitry 110 may further determine that the current SoC 40% may be sufficient to commute from home to the Golf club and from the Golf Cub to the restaurant but may be insufficient for commuting from the restaurant to the home location (e.g., the subsequent predicted charging session) where the vehicle 102 is usually charged as per the learnt charging pattern. In such a scenario, the processing circuitry 110 may determine available charging opportunities during the second time-interval. In the ongoing example, the available charging opportunities may be at Golf Club and at restaurant parking. The processing circuitry 110 may select the most optimal charging opportunity for charging the vehicle 102 between the charging opportunities at the Golf Club and the restaurant parking and generate the recommended charging plan according to the most optimal charging opportunity. The processing circuitry 110 may be configured to generate a recommended charging plan to charge the vehicle 102 at the Golf Club as the Golf Club may have lower cost of charging.

The processing circuitry 110 may be further configured to output the recommended charging plan at the second time-instance. The processing circuitry 110 may be configured to output the recommended charging plan via the user interface 112 of the user device 114. The recommended charging plan may be presented by rendering a message, for example, “Your current state of charge may not be enough, please charge to attain 25% of SoC.”

In some embodiments, the user of the vehicle 102 may not be satisfied with the recommended charging plan. Therefore, the user device 114 may be used by the user to provide a user input, to the processing circuitry 110, to modify the recommended charging plan. In the ongoing example, the user may have finished their game at the “Golf Club” early and may not wish to wait for charging the energy storage device 108. Therefore, the processing circuitry 110 may modify the recommended charging plan to recommend charging the energy storage device 108 at the restaurant parking. In another scenario, the processing circuitry 110 may determine that charging at the restaurant is more expensive as compared to charging the vehicle 102 at home. In such a scenario, the processing circuitry 110 may generate the recommended charging plan that indicates a recommended SoC to be attained. For example, the processing circuitry 110 may generate the recommended charging plan that recommends the user to charge the vehicle 102 up to 25% (i.e., minimum SoC required to avail the more optimal charging opportunity) using the charging facility provided at the restaurant as the vehicle 102 only requires 23% SoC to commute from the restaurant to the home location. In other words, the recommended charging plan helps the user to save unnecessary cost of charging.

In some embodiments, the processing circuitry 110 may be further configured to execute a comparative analysis of an actual charging log and a recommended charging log associated with the vehicle 102. The actual charging log may indicate an actual charging history of the vehicle 102. The recommended charging log may indicate a charging history in accordance with the alternate charging plan and/or the recommended charging plan.

In some embodiments, the actual charging log may be same as the recommended charging log. In such embodiments, alternate charging plans and recommended charging plans generated by the processing circuitry 110 may have been followed to charge the energy storage device 108.

In some embodiments, the actual charging log may be different from the recommended charging log. In such embodiments, at least one alternate charging plan or at least one recommended charging plan generated by the processing circuitry 110 may have not been followed to charge the energy storage device 108.

In some embodiments, the processing circuitry 110 may be configured to generate a recommended charging plan based on a detected SoC being less than a threshold SoC. The recommended charging plan may be indicative of a subsequent charging opportunity for charging the energy storage device 108.

In some embodiments, the energy storage device 108 may be a standalone component or may be associated with any other device (e.g., a laptop, a television, an invertor, or any other electric or electromechanical component) that may be different from the vehicle 102. In such embodiment, the vehicle usage may be referred to as energy storage device usage that may be indicative of use of electric charge stored in the energy storage device 108.

It will be apparent to a person of ordinary skill in the art that charging the energy storage device 108 may be same as charging the vehicle 102.

FIG. 1B is another block diagram that illustrates another system environment for implementation of the charging recommendation method, in accordance with another exemplary embodiment of the disclosure. Referring to FIG. 1B, the system environment 100B includes the vehicle 102, the database server 104, the communication network 106, and a control server 118. The vehicle 102 is shown to include the energy storage device 108. The control server 118 is shown to include the processing circuitry 110 having the neural network 116. The control server 118 may be communicatively coupled to the vehicle 102, the database server 104, and the user device 114 by way of the communication network 106. In such an embodiment, one or more operations required for generating alternate charging plans and/or recommended charging plans (as described in the foregoing description of FIG. 1A) may be executed at the control server 118 instead of the vehicle 102. The control server 118 may communicate the generated alternate charging plan and/or the recommended charging plan to the user device 114 so as to output the alternate charging plan and/or the recommended charging plan via the user interface 112 of the user device 114.

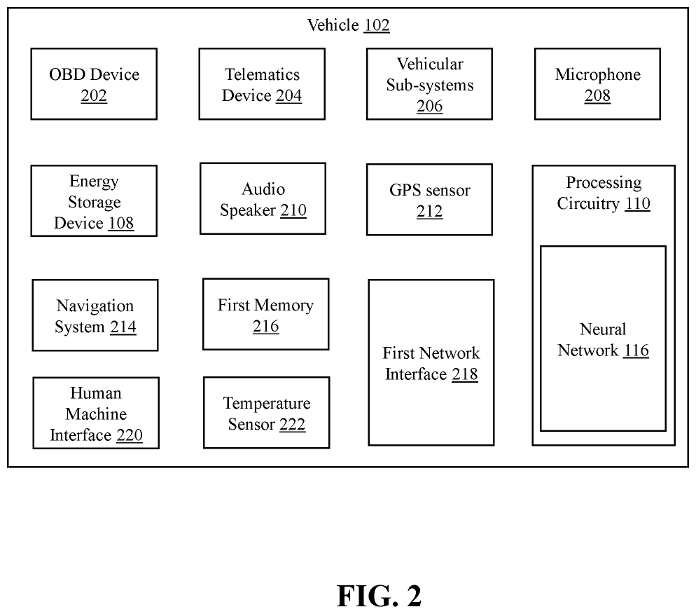

FIG. 2 is a block diagram of a vehicle, in accordance with an exemplary embodiment of the disclosure. Referring to FIG. 2, the vehicle 102 is shown to include an on-board diagnostic (OBD) device 202, a telematics device 204, vehicular sub-systems 206, a microphone 208, an audio speaker 210, a GPS sensor 212, a navigation system 214, a first memory 216, a first network interface 218, a human machine interface 220, and a temperature sensor 222. As described earlier, the vehicle 102 also includes the energy storage device 108 and the processing circuitry 110 having the neural network 116.

The OBD device 202 may include suitable logic, circuitry, interfaces, and/or code, executable by the circuitry, that may be configured to diagnose a plurality of components (such as, an engine, a battery, or the like) of the vehicle 102. The OBD device 202 may be further configured to generate one or more diagnostic trouble codes (DTCs) based on diagnosis of the plurality of components of the vehicle 102. The OBD device 202 may be a standalone device installed in the vehicle 102 or may be integrated with one of the plurality of components of the vehicle 102. The OBD device 202 may be configured to diagnose the components periodically (such as, daily, after a predefined number of days, weekly, monthly, yearly, and so forth) or when instructed by the user of the vehicle 102. The OBD device 202 may be communicatively coupled to the processing circuitry 110 and may communicate the one or more DTCs generated thereby based on diagnosis of the plurality of components of the vehicle 102. In some embodiments, the processing circuitry 110 may generate the alternate charging plan while taking the received DTCs and health of the plurality of components (that may affect electric charge consumption of each component of the plurality of components) into consideration.

The telematics device 204 may include suitable logic, circuitry, interfaces, and/or code, executable by the circuitry, that may be configured to perform one or more operations for obtaining current SoC (e.g., the current SoCs at the first and second time-instances) and vehicle usage information (e.g., first and second vehicle usage information) of the vehicle 102. The vehicle usage information may further include operational data of one or more components (e.g., a battery, an alternator, brakes, accelerator, or the like) of the vehicle 102, vehicle specifications stored in the first memory 216 of the vehicle 102, sensor data collected by each sensor (e.g., GPS sensor 212, the temperature sensor 222, or the like), data collected by the microphone 208, a service log, a charging log, a time-series of charge status, or the like of the vehicle 102 stored in the first memory 216. The service log may include details (such as date, duration, cost, maintenance center, issue, resolution, or the like) associated with each maintenance session of the vehicle 102. The charging log may include a time-series of charging sessions of the vehicle 102. The time-series of charge status may include a time-series record of electric charge availability with the energy storage device 108. The telematics device 204 may be configured to communicate with one or more components of the vehicle 102 to obtain abovementioned information (e.g., the operational data, the service log, the time-series charge status, the charging log, or the like). The telematics device 204 may be communicatively coupled to the processing circuitry 110. The telematics device 204 may be further configured to transmit the received information to the processing circuitry 110 via one of the first network interface 218 or the communication network 106. The telematics device 204 may communicate the abovementioned information continuously, periodically, or when prompted via the user device 114 associated with the vehicle 102 or the processing circuitry 110. The telematics device 204 may be a standalone device or may be integrated with an in-built component (for example, the OBD device 202) of the vehicle 102.

The vehicular sub-systems 206 may include one or more components or a group of components of the vehicle 102. The vehicular sub-systems 206 may include electrical and/or electromechanical systems (e.g., lighting system, braking system, suspension system, vehicle body, steering system, infotainment system, or the like) that may or may not draw power from the energy storage device 108 or any other power source (e.g., battery) included in the vehicle 102.

The microphone 208 may include suitable logic, circuitry, interfaces, and/or code, executable by the circuitry, that may be configured to detect audio sound present in vicinity of the vehicle 102. The audio sound may include one or more voice responses being uttered by the user of the vehicle 102. The microphone 208 may be configured to communicate the audio data (or sound) to the processing circuitry 110 and/or the telematics device 204. The processing circuitry 110 may be configured to generate or modify the alternate charging plan and/or the recommended charging plan for the vehicle 102 based on the received audio data.

The audio speaker 210 may include suitable logic, circuitry, interfaces, and/or code, executable by the circuitry, that may be configured to generate one or more audio signals associated with the alternate charging plan for charging the energy storage device 108 of the vehicle 102. In some examples, the audio speaker 210 may be configured to generate one or more audio signals associated with an alarm caused due to a non-recommended operation of the vehicle 102 while following the alternate charging plan. The audio speaker 210 may be further controlled by the processing circuitry 110 to generate an audio signal to provide one or more recommendations to the user of the vehicle 102.

The GPS sensor 212 may include suitable logic, circuitry, interfaces, and/or code, executable by the circuitry, that may be configured to detect a current location of the vehicle 102. The GPS sensor 212 may be configured to communicate the detected location to the processing circuitry 110, the navigation system 214, and/or the telematics device 204. In other words, the navigation system 214 may utilize location data received from the GPS sensor 212 to provide navigation assistance that may assist the user of the vehicle 102 in following the alternate charging plan and/or the recommended charging plan.

The navigation system 214 may include suitable logic, circuitry, interfaces, and/or code, executable by the circuitry, that may be configured to detect a real-time (or near real-time) location of the vehicle 102. Further, the navigation system 214 may be configured to determine one or more routes that may be suitable for the vehicle 102 to follow in accordance with its current SoC (the current SoCs at the first and second time-instances), the alternate charging plan, and/or the recommended charging plan. The navigation system 214 may be further configured to determine one or more routes to reach a recommended charging location. The navigation system 214 may be further configured to determine one or more routes to reach a charging location in conformity with one of the alternate charging plan and/or the recommended charging plan. The navigation system 214 may be further configured to present the determined routes via a separate screen or the HMI 220.

The first memory 216 may include suitable logic, circuitry, and interfaces that may be configured to store one or more instructions which when executed by the processing circuitry 110 may cause the processing circuitry 110 to perform various operations for implementing the alternate charging plan and/or the recommended charging plan. The first memory 216 may be configured to store information associated with the vehicle 102. The first memory 216 may be further configured to store historical data (vehicle usage, charging log, one or more images of visible damages, or the like) associated with the vehicle 102. The first memory 216 may be accessible by the processing circuitry 110. Examples of the first memory 216 may include, but are not limited to, a random access memory (RAM), a read only memory (ROM), a removable storage drive, a hard disk drive (HDD), a flash memory, a solid-state memory, or the like. It will be apparent to a person skilled in the art that the scope of the disclosure is not limited to realizing the first memory 216 in the vehicle 102, as described herein. In another embodiment, the first memory 216 may be realized in form of the database server 104 (as shown in FIGS. 1A and 1B) or a cloud storage working in conjunction with the processing circuitry 110, without departing from the scope of the disclosure.

The first network interface 218 may include suitable logic, circuitry, interfaces, and/or code, executable by the circuitry, that may be configured to enable the processing circuitry 110 to communicate with the database server 104 and the control server 118. The first network interface 218 may be implemented as a hardware, software, firmware, or a combination thereof. Examples of the first network interface 218 may include a network interface card, a physical port, a network interface device, an antenna, a radio frequency transceiver, a wireless transceiver, an Ethernet port, a universal serial bus (USB) port, or the like.

The HMI 220 may include suitable logic, circuitry, interfaces, and/or code, executable by the circuitry, that may be configured to perform, when accessed (or manipulated) by the user of the vehicle 102, one or more operations for controlling one or more features of the vehicle 102. The HMI 220 may be touch-controlled, voice-controlled, gesture-controlled, or the like. In an example, the HMI 220 may include a touch screen interface, one or more buttons, one or more knobs, or the like for receiving one or more user inputs from the user of the vehicle 102. The HMI 220 may further include a display screen configured to present the alternate charging plan, the recommended charging plan, or the like outputted by the processing circuitry 110.

The temperature sensor 222 may include suitable logic, circuitry, interfaces, and/or code, executable by the circuitry, that may be configured to detect a magnitude of temperature of the one or more components (for example, energy storage device 108, or the like) of the vehicle 102. The temperature sensor 222 may be configured to communicate the detected temperature (e.g., sensor data) to the processing circuitry 110 and/or the telematics device 204. An alarm or notification may be generated by the processing circuitry 110 based on the detected temperature being greater than a threshold temperature that may interfere with the alternate charging plan or the recommended charging plan being followed to charge the energy storage device 108.

It will be apparent to a person skilled in the art that the vehicle 102 shown in FIG. 2 is exemplary and does not limit the scope of the disclosure. In other embodiment, the vehicle 102 may include one or more additional or different components configured to perform additional or different operations.

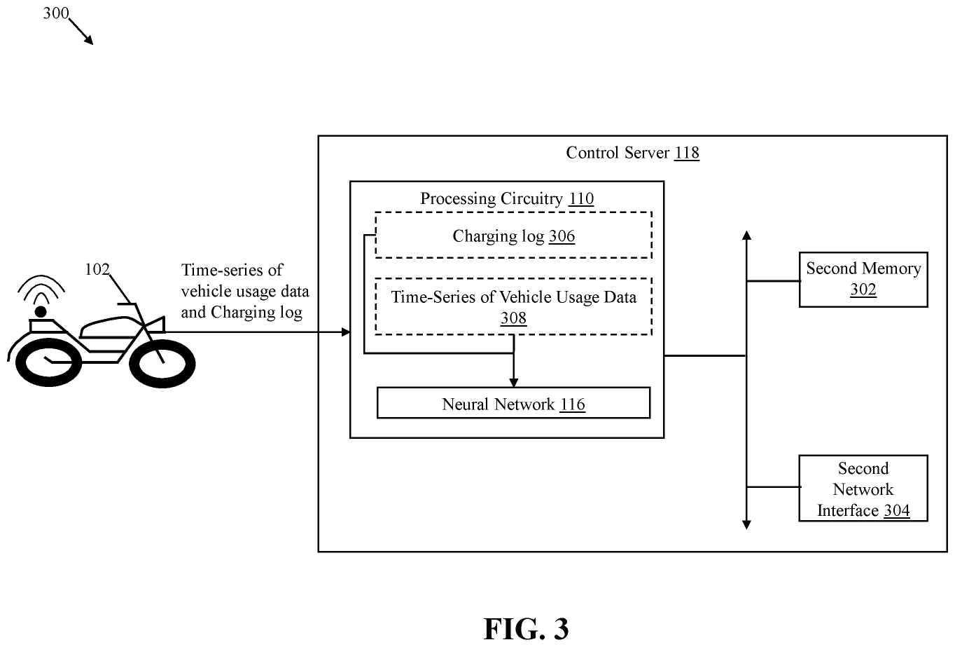

FIG. 3 is a schematic diagram that illustrates an exemplary environment for training a neural network, in accordance with an exemplary embodiment of the disclosure. Referring to FIG. 3, the exemplary environment 300 is shown to include the vehicle 102 and the control server 118. The control server 118 may include a second memory 302, a second network interface 304, and the processing circuitry 110. The second memory 302 may be operationally similar to the first memory 216. The second memory 302 may be further configured to store time-series of vehicle usage data and charging log received by the control server 118. The second network interface 304 may be operationally similar to the first network interface 218.

During the training phase, the processing circuitry 110 may be configured to receive time-series of vehicle usage data and charging log of the vehicle 102 from the vehicle 102 and/or the database server 104. The received time-series of vehicle usage data and charging log may correspond to the training time-interval. The charging log may include data associated with one or more charging sessions that may have been initiated during the training time-interval to charge the vehicle 102. The time-series of vehicle usage data may include details pertaining to the use of the vehicle 102 during the training time-interval (as described in the foregoing description of FIG. 1A). That is to say, the processing circuitry 110 may receive the charging log (as depicted within a dotted box 306) and the time-series of vehicle usage data (as shown within a dotted box 308). The processing circuitry 110 may be configured to provide the charging log 306 and the time-series of vehicle usage data 308 as input to the neural network 116. The neural network 116 may correlate the time-series of vehicle usage data 308 with the charging log 306 of historical charging sessions. Based on such correlation, the neural network 116 may learn the vehicle usage pattern and the charging pattern for the vehicle 102. Although the neural network 116 is shown to learn the vehicle usage pattern and the charging pattern of one vehicle, in an actual implementation, the neural network 116 may learn the vehicle usage pattern and the charging pattern of multiple vehicles without deviating from the scope of the disclosure. In such an embodiment, the learnt patterns may be associated with a vehicle identifier of corresponding vehicle.

The neural network 116 may be further configured to learn an impact of the charging sessions on the SoH of the energy storage device 108. For example, if the SoH of the energy storage device 108 remains unaffected or improves after a first charging session, the neural network 116 may learn that various charging parameters (such as type of charging, duration of charging, initial SoC, attained SoC, or the like) at the first charging session may not have any affect or may positively affect the SoH of the energy storage device 108. However, if the SoH of the energy storage device 108 decreases after a second charging session, the neural network 116 may learn that various charging parameters at the second charging session have negatively impact on the SoH of the energy storage device 108. In other words, the neural network 116 may be trained to learn a correlation between charging and SoH of the energy storage device 108.

The neural network 116 may be further configured to learn a correlation between vehicle usage and charging pattern of the vehicle 102. The correlation may be indicative of an amount of electric charge required to accommodate specific vehicle usage. For example, the neural network 116 may learn commuting between a home parking location and office of the user of the vehicle 102 may require the energy storage device 108 to be 20% charged. In an example, the charging log may indicate that on each working day of office, the user of the vehicle 102 may tend to charge the energy storage device 108 at their office parking where fast-charging facilities for charging the energy storage device 108 may be available. However, charging the energy storage device 108 using the fast-charging facility may be expensive as compared to charging the energy storage device 108 at home. Also, the neural network 116 may learn that the vehicle 102 may require 20% SoC for commuting from their home to the office parking. Further, based on the time-series of vehicle usage data, the neural network 116 may correlate that on the working days, the vehicle 102 is only driven to commute between home and office. Therefore, the neural network 116 may learn that charging at the office parking may not be required if the energy storage device 108 remains 25% charged when the vehicle 102 reaches the office parking.

In another example, the time-series of vehicle usage data may be indicative of a detour taken by the vehicle 102 on every alternate day while coming from the office to home. Such detour may require an additional 10% of electric charge availability with the energy storage device 108. Therefore, the neural network 116 may learn that the energy storage device 108 should be 35% charged when the vehicle 102 leaves the office parking to avoid charging while on the detour or on way to the home.

The exemplary environment 300 corresponds to the system environment 100B. In other embodiments, when the processing circuitry 110 may be included in the vehicle 102, the neural network 116 may be trained in a similar manner as described in foregoing description of FIG. 3. It will be apparent to a person skilled in the art that the exemplary environment 300 is exemplary and does not limit the scope of the disclosure.

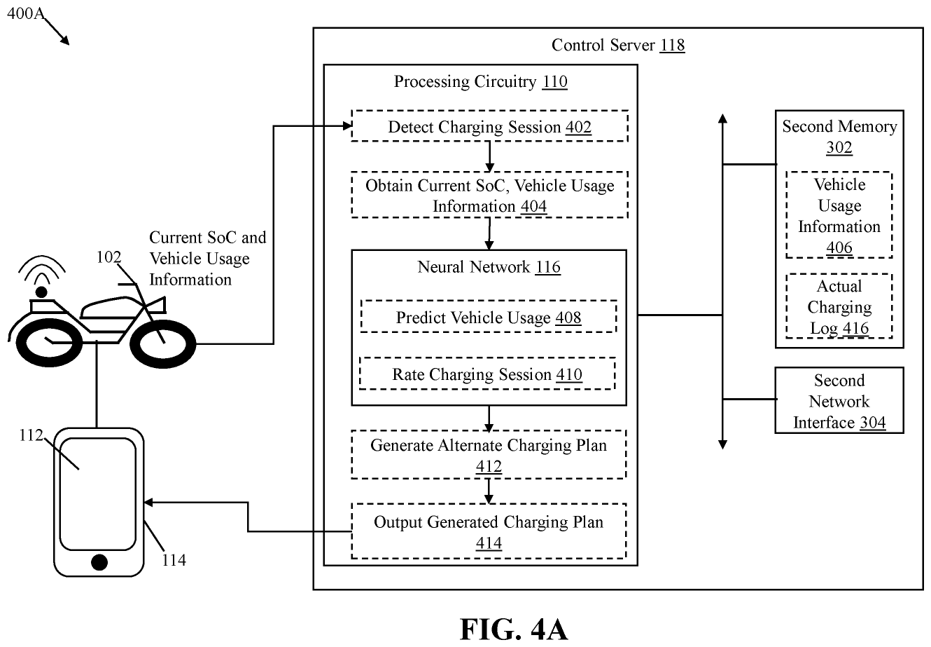

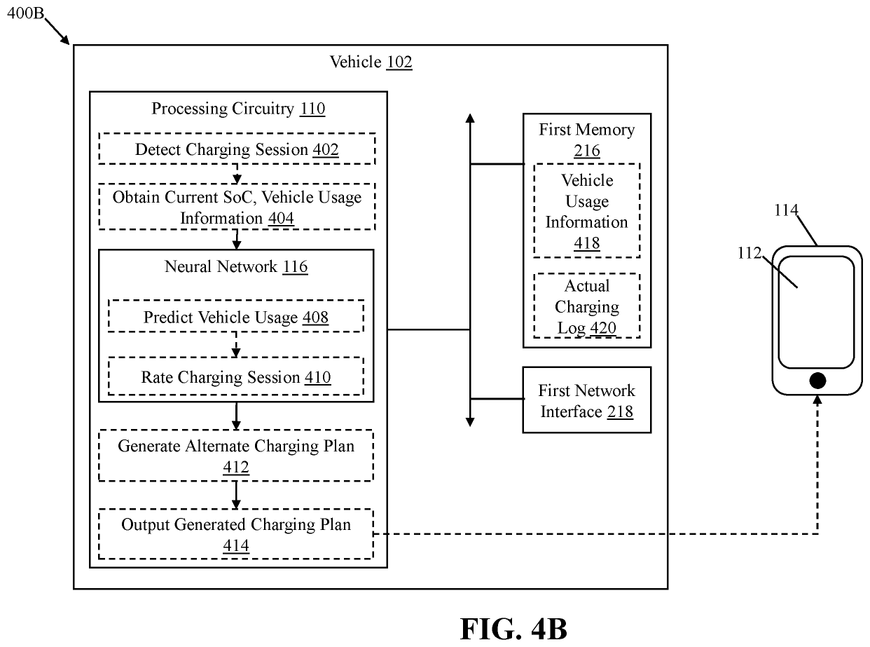

FIG. 4A is a schematic diagram that illustrates an exemplary environment for generating the alternate charging plan for the vehicle, in accordance with an exemplary embodiment of the disclosure. Referring to FIG. 4A, illustrated is the exemplary environment 400A for generating the alternate charging plan for the vehicle 102. As shown, the exemplary environment 400A includes the vehicle 102, the user device 114 associated with the vehicle 102, and the control server 118.

The processing circuitry 110 may be configured to detect the charging session (as

depicted by a dotted box 402) initiated by the user of the vehicle 102 at the current time-instance. The processing circuitry 110 may be configured to monitor the energy storage device 108 to detect initiation of the charging session. The processing circuitry 110 may detect the charging session based on a status of the energy storage device 108 being transitioned from “not charging” to “charging.”

Based on detection of the charging session being initiated, the processing circuitry 110 may be configured to obtain the current SoC at the first time-instance associated with the energy storage device 108 of the vehicle 102 and the first vehicle usage information that indicates the usage of the vehicle 102 over the historical time-interval (as depicted by a dotted box 404). The second memory 302 may be configured to store the obtained first vehicle usage information (as shown by another dotted box 406). The historical time-interval occurs prior to the first time-instance. The usage of the vehicle 102 over the historical time-interval may be matched with the learnt vehicle usage pattern to determine tentative subsequent usage of the vehicle 102 as well as electric charge consumption during such usage of the vehicle 102. The processing circuitry 110 may be configured to provide the obtained current SoC at the first time-instance and the first vehicle usage information to the trained neural network 116.

The neural network 116 may be configured to predict vehicle usage over the first time-interval (as depicted by a dotted box 408) based on the obtained first vehicle usage information. The neural network 116 may also take into account the learnt vehicle usage pattern while predicting the vehicle usage. The neural network 116 may predict the vehicle usage based on a current location (e.g., home, office, enroute, or the like) and the vehicle usage pattern that may be indicative of subsequent actions performed by the vehicle 102 when it was at the current location in past. For example, the first vehicle usage information may be indicative of the current location of the vehicle 102 to be at an office parking. The vehicle usage pattern may indicate that the vehicle 102 has traveled to home from office parking at 90% of times when the vehicle 102 was parked at the office parking in the past. Therefore, the neural network 116 may predict that the vehicle 102 may be used (i.e., vehicle usage) for commuting from the office parking to home. That is to say, that the predicted vehicle usage may be indicative of use of the vehicle 102 during the first time-interval. Examples of the first time-interval may include, but are not limited to, 30 minutes, 1 hour, 1.5 hours, 2 hours, 2.5 hours, 3 hours, and so on.

In some embodiments, the predicted vehicle usage includes at least one of one or more routes to be traveled by the vehicle 102, the time of travel corresponding to each route to be traveled by the vehicle 102, the one or more driving parameters, the count of drivers of the vehicle 102, the count of riders of the vehicle 102, and the auxiliary power consumption by one or more vehicle accessories during one or more trips by the vehicle 102, over the first time-interval.

The one or more routes to be traveled by the vehicle 102 over the first time-interval may refer to route(s) to be traveled by the vehicle 102 subsequent to the detected charging session. The time of travel corresponding to each route to be traveled by the vehicle 102 over the first time-interval may refer to a time duration for which the vehicle 102 is estimated to travel via each route.

The one or more driving parameters to be traveled by the vehicle 102 over the first time-interval may refer to various attributes of driving (e.g., velocity, braking, acceleration, mode of operation, or the like) that may affect electric charge consumption by the vehicle 102. The one or more driving parameters may include the velocity profile, the braking profile, the acceleration profile, and the mode of operating the vehicle 102 over the first time-interval. The velocity profile of the vehicle 102 may refer to a range of velocity within which the vehicle 102 is driven. The range of velocity may have a minimum velocity with which the vehicle 102 is driven and a maximum velocity with which the vehicle 102 is driven. In an instance, a vehicle may be driven with a minimum speed of 30 km/hr and a maximum speed of 80 km/hr. Therefore, a velocity profile of the vehicle may indicate that the vehicle may be driven with a velocity ranging between 30 km/hr and 80 km/hr. The braking profile of the vehicle 102 may be indicative of braking of the vehicle 102 with respect to a speed at which the vehicle 102 was being driven when its brakes were applied. The acceleration profile of the vehicle 102 may be indicative of information associated with a pattern in which the vehicle 102 is accelerated. The acceleration profile may refer to a range of speed within which the vehicle 102 is accelerated with respect to time. In an instance, accelerating the vehicle 102 from 40 kilometre/hour (km/hr) to 120 km/hr within 10 seconds may consume double electric charge as it would have required to accelerate the vehicle 102 gradually.

Further, the vehicle 102 may have a plurality of modes of operation. Each mode of the plurality of modes may allow or restrict use of one or more features or components of the vehicle 102. Examples, of the modes of operation may include, but are not limited to eco mode, sport mode, night mode, or the like. During eco mode, essential features and components (e.g., engine, brake, navigation, or the like) may be allowed to be operational. Therefore, use of the vehicle 102 in the eco mode may consume significantly low electric charge. The sport mode of the vehicle 102 may allow all the features and components (e.g., engine, brakes, music player, air conditioner, the HMI 220, or the like) of the vehicle 102 to be operational. Therefore, use of the vehicle 102 in the sport mode may require significantly high electric charge. The night mode of operation of the vehicle 102 may allow use of each feature of the vehicle 102 within a threshold level. Therefore, use of the vehicle 102 in the night mode may consume moderate amount of electric charge. For example, while the vehicle 102 may be operating in the night mode, horn sound may be reduced within a first threshold level and music player volume may be restricted to a second threshold level. The mode of operation of the vehicle 102 may impact requirement of electric charge for the predicted vehicle usage. For example, the predicted vehicle usage may consume first amount of electric charge when the vehicle 102 may be operated in the eco mode. The predicted vehicle usage may consume second amount of electric charge when the vehicle 102 may be operated in the sports mode. The first amount of electric charge may be less than a second amount of electric charge.

The count of drivers of the vehicle 102 over the first time-interval may refer to a count of users of the vehicle 102 that may drive the vehicle 102 over the first time-interval. In an example, the vehicle 102 may be used by the user to drop their kids to school. Subsequently, another user (e.g., wife or husband of the user) may use the vehicle 102 to commute to a supermarket. Therefore, in such an example the count of drivers of the vehicle 102 over the first time-interval may be “two.” An increase in count of drivers may increase exposure of the vehicle 102 to different driving styles that may correspond to different rate of consumption of electric charge by the vehicle 102. The count of riders of the vehicle 102 over the first time-interval may refer to a total number of riders that may use the vehicle 102 during the first time-interval. The riders may either be driving the vehicle 102 or sitting on a passenger/pillion seat. An increase in count of riders may increase electric charge consumption by the vehicle 102 in accordance with effective weight and other parameters associated with the vehicle usage. The auxiliary power consumption by one or more vehicle accessories during one or more trips by the vehicle 102 may refer to electric charge consumed by use of one or more accessories (e.g., music player, air conditioner, or the like) of the vehicle 102 during the first time-interval.

Subsequently, the neural network 116 may rate the detected charging session (as shown by a dotted box 410). The neural network 116 may estimate consumption of electric charge to accommodate the predicated vehicle usage. Subsequently, the neural network 116 may rate the charging session based on a comparison between the estimated consumption of electric charge and the current SoC. The neural network 116 may rate the detected charging session as optimal or suboptimal.

In some embodiments, the charging session may be rated optimal when the current SoC may not be sufficient to accommodate the vehicle usage between the first time-instance and a subsequent charging opportunity. In another embodiment, the charging session may be rated suboptimal when the current SoC at the first time-instance may be sufficient to accommodate the vehicle usage between the first time-instance and the subsequent charging opportunity with the subsequent charging opportunity being more cost effective for the user.

In some embodiments, the neural network 116 may rate the current charging session based on one of the one or more driving parameters associated with the predicted vehicle usage of the vehicle 102, the cost of charging during the current charging session, the charging time duration required for the current charging session, and the impact of the current charging session on the state of health (SoH) of the energy storage device 108. The current charging session may be rated optimal in case the energy storage device 108 when charged during the current charging session may accommodate the predicted vehicle usage as well as electric charge consumption due to the one or more driving parameters. The current charging session may be rated optimal in case the energy storage device 108 when charged during the current charging session may be most cost-efficient option of charging the energy storage device 108. The current charging session may be rated suboptimal in case the energy storage device 108 when charged during the current charging session may be cost-intensive and may not be most suitable option for charging the energy storage device 108 and a subsequent charging opportunity may be cost-efficient and more suitable option for charging the energy storage device 108. The current charging session may be rated optimal in case the current charging session is in accordance with a charging recommendation (one or more rules for maintaining SoH of the energy storage device 108) for the energy storage device 108. The current charging session may be rated suboptimal in case in case the charging session may not be in accordance with the charging recommendation for the energy storage device 108 and hence may negatively impact the SoH of the energy storage device 108.

In an example, the processing circuitry 110 may detect a charging session being initiated for the vehicle 102. Subsequently, the processing circuitry 110 may obtain the current SoC and the first vehicle usage information associated with the vehicle 102. The current SoC of the vehicle 102 may be 40%. The first vehicle usage information may indicate that the vehicle 102 is driven to a restaurant that is 50 kilometers away from a home location of the vehicle 102 and is currently parked in a parking of the restaurant. Further, as per the learnt vehicle usage pattern of the vehicle 102, the neural network 116 may predict that the vehicle 102 may be subsequently used to commute from the restaurant to the home location of the vehicle 102 during the first time-interval.

Also, the neural network 116 may determine that the vehicle 102 may require 30% electric charge availability with the energy storage device 108 to return to the home location from the restaurant. Thus, when the processing circuitry 110 detects the charging session being initiated for the vehicle 102 at the restaurant, the neural network 116 may determine that charging the energy storage device 108 at the restaurant may be expensive and may be unnecessary as the vehicle 102 already has sufficient SoC to reach from restaurant to home where the vehicle 102 could be charged at a lower cost as compared to the restaurant. Therefore, the neural network 116 may rate the detected charging session as suboptimal in comparison to the subsequent charging opportunity (e.g., charging the vehicle 102 at home). However, when the detected charging session may be rated optimal as compared to subsequent charging opportunities, the processing circuitry 110 may be configured to take no further action.

The processing circuitry 110 may be further configured to generate the alternate charging plan (as depicted by a dotted box 412) based on the detected charging session initiated at the current time-instance being rated suboptimal. The processing circuitry 110 may be configured to generate the alternate charging plan in way that when charged in accordance with the alternate charging plan, the energy storage device 108 may have electric charge that may be sufficient to accommodate the estimated electric charge consumption by the vehicle 102 during the first time-interval. Further, the processing circuitry 110 may be configured to rate the alternate charging plan in comparison to the detected charging session. The generated alternate charging plan may be rated optimal and accommodates the predicted vehicle usage in the first time-interval. In such an embodiment, the processing circuitry 110 may be configured to output the generated alternate charging plan (as shown by a dotted box 414) at the current time-instance. The processing circuitry 110 may be configured to output the generated charging plan by way of the user device 114. The processing circuitry 110 may be configured to output the generated alternate charging plan by way of presenting the alternate charging plan via the user interface 112 of the user device 114 associated with the vehicle 102. In other words, the processing circuitry 110 may recommend the user to not charge the vehicle 102 at the current time instance by outputting the alternate charging plan.

In some embodiments, the alternate charging plan may include the alternate location to charge, the alternate charging speed, the alternate cost of charging, the alternate time-instance to charge, and the alternate SoC associated with the energy storage device 108 that may be different from the current SoC to initiate the alternate charging session of the energy storage device 108.

The alternate location to charge may refer to a charging station or charging location, different from a current charging location. The alternate location to charge may be more suitable to charge the energy storage device 108 as compared to a current location of charging. In some embodiments, the processing circuitry 110 may be configured to segregate charging locations in a geographical area associated with the vehicle 102 as private charging locations and public charging locations. The private charging locations may be owned by an individual that may provide charging facilities when convenient by the individual. The public charging locations may be owned by an organization that provide charging facilities to vehicles for charging as per their timings and prices. In some embodiments, the public charging locations may provide the charging facilities at a lower price as compared to the private charging locations.

The alternate charging speed may refer to a first charging speed of charging the energy storage device 108 that may be different from a second charging speed of charging the energy storage device 108 during the current charging session. For example, the vehicle 102 may be predicted to be parked at a parking location for 3 hours. In such a scenario, if the current charging session is initiated using fast charging which is more expensive than slow charging, the alternate charging plan may be outputted to recommend the user to use slow charging as the vehicle 102 has sufficient time in the parking to attain required SoC. Thus, the alternate charging plan recommending to use slow charging may be more cost effective (e.g., optimal) for the user as compared to the current charging session.

The alternate cost of charging the energy storage device 108 may refer to a cost of charging the energy storage device 108 that may be different from a cost of charging the energy storage device 108 at the current time-instance. The alternate cost of charging may be lower than the cost of charging the energy storage device 108 at the current time-instance. The alternate time-instance to charge the energy storage device 108 may refer to a time-instance for charging the energy storage device 108 that may be different from the current time-instance. The alternate time-instance may occur after the current time-instance. The alternate time-instance may be recommended in the alternate charging plan when the energy storage device 108 has enough electric charge to accommodate vehicle usage between the current time-instance and the subsequent charging opportunity, with the subsequent charging opportunity being optimal as compared to the current charging session. The alternate time-instance may be more suitable for charging the energy storage device 108 as compared to the current time-instance. The alternate SoC associated with the energy storage device 108 may refer to an SoC associated with the energy storage device 108 that may be different from the current SoC. The alternate SoC may be less than the current SoC associated with the energy storage device 108. The alternate SoC may be recommended in the alternate charging plan when charging the energy storage device 108 at the alternate SoC is more suitable for the SoH of the energy storage device 108 and/or subsequent usage of the vehicle 102.

In some embodiments, the alternate charging plan may not be convenient for the user of the vehicle 102. Therefore, the user input for modifying the alternate charging plan and generating the new alternate charging plan may be received via the user device 114. The user input may be indicative of one of a convenient time-instance to charge the energy storage device 108, a convenient cost to charge the energy storage device 108, a convenient location to charge the energy storage device 108, a different cost to charge the energy storage device 108 that may be affordable to the user of the vehicle 102, a convenient speed of charging the energy storage device 108, and a convenient SoC to charge the energy storage device 108. Based, on the received user input, the processing circuitry 110 may be configured to modify the generated alternate charging plan by incorporating an intent of the user input. In an example, the modification may be performed by changing one of the alternate location to charge with the convenient location to charge the energy storage device 108, the alternate charging speed with the convenient speed of charging the energy storage device 108, the alternate cost of charging with the different cost to charge the energy storage device 108 that may be affordable to the user of the vehicle 102, the alternate time-instance to charge with the convenient time-instance to charge, and the alternate SoC to charge the energy storage device 108 with the convenient SoC to charge the energy storage device 108. Based on such modification, the processing circuitry 110 may be configured to regenerate the new alternate charging plan. Subsequently, the processing circuitry 110 may be configured to output the new alternate charging plan at the current time-instance. The processing circuitry 110 may output the new alternate charging plan via the user device 114.

In some embodiments, the alternate charging plan may include an alternate mode of operation of the vehicle 102 that may accommodate the predicted vehicle usage. In some embodiments, the recommended charging plan may further include a recommended mode of operation of the vehicle 102 that may accommodate the predicted vehicle usage.

In some embodiments, the processing circuitry 110 may be further configured to obtain the current SoC of the energy storage device 108 at the second time-instance. The current SoC may be obtained periodically or when prompted via the user device 114. The processing circuitry 110 may be further configured to obtain second vehicle usage information that may be indicative of the usage of the vehicle 102 prior to the second time-instance. Further, the processing circuitry 110 may be configured to predict the vehicle usage over the second time-interval that may occur after the second time-instance. The second time-interval may refer to the time-duration between the second time-instance and a subsequent predicted charging session. Therefore, the processing circuitry 110 may be configured to predict the vehicle usage between the second time-instance and the subsequent predicted charging session. Subsequently, the processing circuitry 110 may be configured to estimate electric charge consumption associated with the vehicle usage over the second time-interval. Further, the processing circuitry 110 may be configured to generate the recommended charging plan for the energy storage device 108 based on the current SoC at the second time-instance being insufficient to accommodate the predicted vehicle usage over the second time-interval. The recommended charging plan may be generated to charge the energy storage device 108 in such a way that the electric charge available with the energy storage device 108 may be sufficient to accommodate the vehicle usage over the second time-interval. That is to say, the recommended charging plan may be generated to charge the energy storage device 108 in such a way that the energy storage device 108 may have electric charge availability equal to the estimated electric charge consumption during the second time-interval. Subsequently, the processing circuitry 110 may be configured to output the generated recommended charging plan via the user device 114.

In an example, the processing circuitry 110 may determine the current SoC at the second time-instance to be 30%. Subsequently, the processing circuitry 110 may be configured to obtain second vehicle usage information which indicates that the vehicle 102 has been used to commute from office to home of the user. Further, the processing circuitry 110 may be configured to predict, based on the second vehicle usage information and the learnt vehicle usage pattern, vehicle usage over the second time-interval. The predicted vehicle usage may indicate that the vehicle 102 may be used to commute to a movie theater from home. The processing circuitry 110 may further determine, based on the learnt charging pattern, that the vehicle 102 has never been charged in vicinity of the movie theatre in the past. Therefore, the processing circuitry 110 may determine that there may not be any charging facility in vicinity of the movie theatre and the vehicle 102 may get the next charging opportunity at home after coming back from the movie theater. Hence, the processing circuitry 110 may be configured to estimate electric charge required for a round trip between home and the movie theater. The processing circuitry 110 may estimate that the energy storage device 108 should be 60% charged to accommodate the round trip between the home and the movie theatre (i.e., estimated energy consumption for the predicted vehicle usage). Therefore, the processing circuitry 110 may be configured to generate the recommended charging plan to charge the energy storage device 108 to 60% before leaving from home to the movie theatre. The processing circuitry 110 may output the recommended charging plan via the user interface 112 of the user device 114 by rendering a notification “Hey! battery may not be charged enough to go for movies tonight. Please charge the battery to 60% before going to the movies.” Further, if the processing circuitry 110 determines that the time duration to charge to 60% is not feasible using slow charging, the recommended charging plan generated by the processing circuitry 110 may indicate the use of fast charging to attain 60% SoC before leaving from home.

In some embodiments, the recommended charging plan may include the recommended location to charge the energy storage device 108, the recommended charging duration to charge the energy storage device 108, the recommended SoC to be attained by charging the energy storage device 108, the route to be traversed to reach the recommended charging location to charge the energy storage device 108, and the recommended auxiliary power consumption of the vehicle 102 while traversing the route to reach the recommended charging location.

The recommended location to charge the energy storage device 108 may refer to a charging station or charging location that may be optimal for charging the energy storage device 108 to accommodate the predicated vehicle usage over the second time-interval. The recommended charging location may be generated in a way that it accommodates the vehicle usage over the second time-interval. The recommended charging duration to charge the energy storage device 108 may refer to a time-interval for which the energy storage device 108 may have to be charged to accommodate the vehicle usage predicted over the second time-interval. The recommended SoC to be attained by charging the energy storage device 108 may refer to a state of charge or an amount of electric charge for which the energy storage device 108 may have to be charged to maintain a desired SoH and/or accommodate the vehicle usage predicted over the second time-interval. The route to be traversed to reach the recommended charging location to charge the energy storage device 108 may refer to a route that should be followed by the vehicle 102 as per the current SoC at the second time-instance and time availability for reaching to the recommended charging station and charging the energy storage device 108. The recommended auxiliary power consumption of the vehicle 102 while traversing the route to reach the recommended charging location may be indicative of vehicle accessories that may be kept operational or should not be kept operational while travelling to the recommended charging location. The recommended auxiliary power consumption of the vehicle 102 while traversing the route to reach the recommended charging location may also be indicative of an amount of electric charge that may be used for operating one or more vehicle accessories.

In some embodiments, the alternate charging plan may be implemented or followed by the user to charge the energy storage device 108. The alternate charging plan may have indicated to charge the energy storage device 108 at an alternate time-instance instead of the current time-instance. However, the vehicle 102 may have had vehicle usage that may be additional to the predicted vehicle usage. In such an embodiment, the processing circuitry 110 may be configured to obtain a third current SoC associated with the energy storage device 108 of the vehicle 102 at a third time-instance. The third time-instance may occur before the alternate time-instance. The processing circuitry 110 may be further configured to obtain third vehicle usage information that indicates vehicle usage of the vehicle 102 prior to the third time-instance. The third vehicle usage information may be indicative of a portion of the predicted vehicle usage that may have been followed by the vehicle 102 before the third time-instance and additional vehicle usage that may have not been predicted earlier.

Further, the processing circuitry 110 may be configured to predict vehicle usage over a third time-interval. The third time-interval may occur after the third time-instance. The vehicle usage predicted over the third time-interval may be based on the portion of the predicted vehicle usage and the additional vehicle usage. That is to say, the vehicle usage over the third time-interval may be predicted based on the portion of the predicted vehicle usage over the third time-interval that may have been followed by the vehicle 102 and the additional vehicle usage associated with the vehicle 102. Based on the predicted vehicle usage over the third time-interval, the processing circuitry 110 may be configured to generate a new charging plan for charging the energy storage device 108. The new charging plan may be generated to take into account energy consumption by the vehicle 102 during the additional vehicle usage. The processing circuitry 110 may be configured to output the new charging plan via the user device 114 at the third time-instance. The processing circuitry 110 may be configured to communicate the new charging plan to the user device 114 to be presented to the user of the vehicle 102 via the user interface 112.

In some embodiments, the processing circuitry 110 may be further configured to execute the comparative analysis of the actual charging log and the recommended charging log associated with the vehicle 102. The actual charging log may indicate an actual charging history of the vehicle 102, for example, actual charging sessions of the vehicle 102. The actual charging log may include a log of charging sessions initiated for charging the energy storage device 108. The actual charging log may be stored in the second memory 302 (as depicted by a dotted box 416). The recommended charging log may be a charging history of the vehicle 102 that is in accordance with alternate charging plans and recommended charging plans generated for charging the energy storage device 108. The recommended charging log may indicate a charging log that may be associated with charging of the energy storage device 108 if each alternate or recommended charging session had been followed for charging the energy storage device 108. During the comparative analysis, a comparison between the recommended charging log and the actual charging log may be performed. Such comparison may signify one or more differences between the recommended charging log and the actual charging log. The one or more differences between the recommended charging log and the actual charging log may be indicative of alternate charging plans or recommended charging plans that may have not been followed for charging the energy storage device 108.

Based on the comparative analysis, the processing circuitry 110 may be configured to generate a comparative analysis report that indicates similarities and differences between the recommended charging log and the actual charging log. The comparative analysis report may further include positive effects of following the alternate charging plan and/or the recommended charging plan and negative effects of not following the alternate charging plan and/or the recommended charging plan. In an example, the comparative analysis report may reflect a count of times the vehicle 102 had been prevented from getting stranded by following the recommended charging plan. In another example, the comparative analysis report may reflect a count of times the vehicle 102 may have had saved money by following the alternate charging plan. In another example, the comparative analysis report may reflect a count of times the SoH of the energy storage device 108 may have suffered when the alternate charging plan or the recommended charging plan may have been neglected by the user of the vehicle 102. Beneficially, the comparative analysis report may enable the user of the vehicle 102 to identify benefits of following alternate charging plans and recommended charging plans. The comparative analysis report may be presented to the user of the vehicle 102 via the user device 114, the HMI 220, or the like. Additionally, the comparative analysis report may further enable the user of the vehicle 102 to identify drawbacks of not following the alternate charging plan and the recommended charging plan. Thus, steering the user towards better charging habits, which in turn may increase longevity of the vehicle 102.

In some embodiments, the actual charging log may be same as the recommended charging log. In such an embodiment, each alternate charging plan and each recommended charging plan may have been complied to charge the energy storage device 108. In another embodiment, the actual charging log may be different from the recommended charging log. In such an embodiment, at least one alternate charging plan and/or at least one recommended charging plan may have not been complied for charging the energy storage device 108.

In some embodiments, the user device 114 may be configured to receive feedback regarding the alternate charging plan and/or the recommended charging plan from the user of the vehicle 102. The feedback may be indicative of usefulness, effectiveness, and efficiency of the alternate charging plan and/or the recommended charging plan in accommodating the vehicle usage.

Subsequently, the processing circuitry 110 may be configured to communicate feedback to the trained neural network 116. In some embodiments, the feedback may be indicative of a deviation between a requirement of electric charge by the vehicle 102 as estimated by the neural network 116 and actual electric charge consumed by the vehicle 102. In another embodiment, the feedback may be indicative of a deviation between an estimated vehicle usage and actual vehicle usage. The neural network 116 may be configured to re-learn based on the feedback provided by the processing circuitry 110.

It will be apparent to a person skilled in the art that FIG. 4A is exemplary and does not limit the scope of the disclosure.

FIG. 4B is another schematic diagram that illustrates another exemplary environment for generating the alternate charging plan for the vehicle, in accordance with an exemplary embodiment of the disclosure. Referring to FIG. 4B, illustrated is the exemplary environment 400B for generating the alternate charging plan and/or the recommended charging plan for the vehicle 102. As shown, the exemplary environment 400B includes the vehicle 102 and the user device 114 associated with the vehicle 102. The exemplary environment 400B works in accordance with the system environment 100A. The processing circuitry 110 and the neural network 116 may operate in a similar fashion as described in conjunction with FIG. 4A. In embodiments, when the processing circuitry 110 may be implemented as an integral component of the vehicle 102, the vehicle usage information (as depicted by a dotted box 418) and the actual charging log (as shown by another dotted box 420) may be stored in the first memory 216 of the vehicle 102.

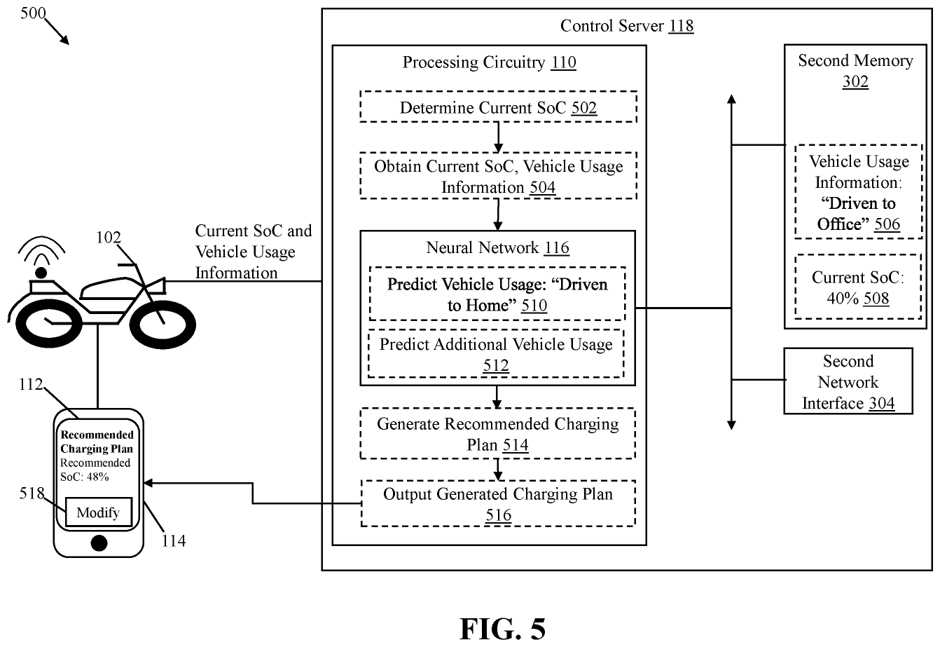

FIG. 5 is a schematic diagram that illustrates an exemplary environment for implementing the charging recommendation method, in accordance with an exemplary embodiment of the disclosure. Referring to FIG. 5, the exemplary environment 500 includes the vehicle 102, the user device 114, and the control server 118. The control server 118 may include the processing circuitry 110, the second memory 302, and the second network interface 304. In other implementations, the vehicle 102 may include the processing circuitry 110. In such implementations, one or more operations of the second memory 302 and the second network interface 304 may be performed by the first memory 216 and the first network interface 218, respectively.

The processing circuitry 110 may be configured to determine the SoC of the energy storage device 108 at the second time-instance or when prompted via the user device 114 to be “40%” (as shown by a dotted box 502) and the second vehicle usage information that indicates the vehicle usage prior to the second time-interval as “Driven to Office” (as shown by another dotted box 504). The current SoC “40%” and the vehicle usage information “Driven to Office” may be stored in the second memory 302 (as shown by dotted boxes 506 and 508). Subsequently, the processing circuitry 110 may communicate the obtained current SoC “40%” and the first vehicle usage information “Driven to Office” to the neural network 116. The neural network 116 may have learnt from the vehicle usage pattern that the vehicle 102 would be driven to home from office and such vehicle usage would require the current SoC of the energy storage device 108 to be at least “35%.” The neural network 116 may be configured to predict the vehicle usage over the second time-interval as “to be Driven to Home” (as shown by a dotted box 510). Additionally, the neural network 116 may determine additional vehicle usage (as shown by a dotted box 512), based on the learnt vehicle usage pattern, for example, the vehicle 102 may get stuck in traffic while commuting between the office and home that may have resulted in consumption of 45% electric charge. The neural network 116 may further determine that charging opportunities are at the office parking and at home as per learnt charging pattern. Therefore, the neural network 116 may generate the recommended charging plan as shown by a dotted box 514) based on electric charge available with the energy storage device 108 being insufficient to accommodate the predicted vehicle usage.

The recommended charging plan may include the recommended SoC “48%.” Hence, the generated recommended charging plan may be outputted by the processing circuitry 110 (as shown by a dotted box 516). The outputted recommended charging plan may be presented to the user of the vehicle 102 via the user interface 112 of the user device 114. As shown in FIG. 5, the presented recommended charging plan may include the alternate SoC to be “48%.” Further, the processing circuitry 110 may receive a user input, provided by way of a user-selectable option 518 to modify the recommended charging plan. Further, the user input may also indicate additional usage of the vehicle 102 to commute to a restaurant. The processing circuitry 110 may determine, based on a location of the restaurant, that the vehicle 102 may require “10%” of charge to reach the restaurant from office and another “55%” to commute from the restaurant to home. Therefore, the neural network 116 may generate a new charging plan that may indicate the recommended SoC to be “70%.”

It will be apparent to a person of ordinary skill that FIG. 5 is exemplary and does not limit the scope of the disclosure.

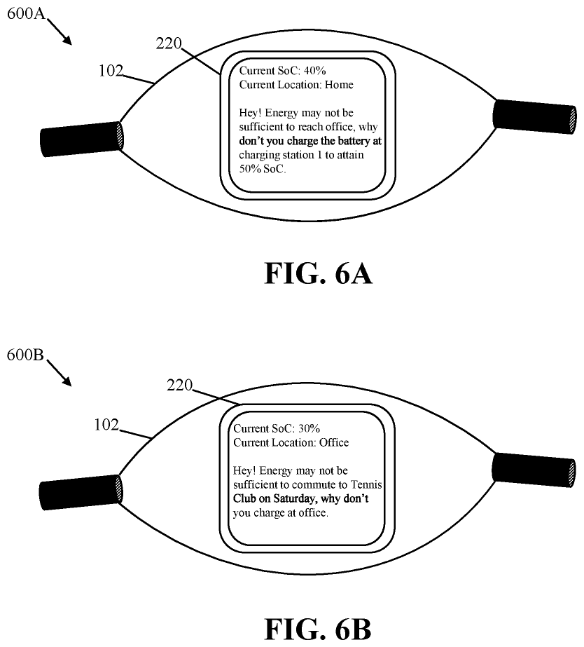

FIGS. 6A and 6B are schematic diagrams that, collectively, illustrate exemplary scenarios for presenting charging plans, in accordance with an exemplary embodiment of the disclosure. Referring to FIG. 6A, illustrated is an exemplary environment 600A that includes the HMI 220 of the vehicle 102. In the exemplary environment 600A, a current SoC of the vehicle 102 may be “40%” and a current location of the vehicle 102 may be “Home.” The processing circuitry 110 may detect a start-up sequence of the vehicle 102 being initiated. Subsequently, the processing circuitry 110 may determine a subsequent charging opportunity for charging the energy storage device 108 to be at office parking. Further, the processing circuitry 110 may determine, based on the learnt vehicle usage pattern, charge consumption for commuting between “Home” and “Office” may be “50%.” Therefore, vehicle usage before the vehicle 102 reaches the office parking may require the energy storage device 108 to be “50%.” The processing circuitry 110 may be configured to present a recommended charging plan via the HMI 220. The recommended charging plan may include a recommendation “Hey! Energy may not be sufficient to reach office, why don't you charge the battery at the charging station 1 to attain 50% SoC.”

Referring to FIG. 6B, illustrated is an exemplary environment 600B that includes the HMI 220 of the vehicle 102. In the exemplary environment 600B, a current SoC of the vehicle 102 may be “30%” and a current location of the vehicle 102 may be “Office.” Based on past charging patterns, the neural network 116 may have learnt that the vehicle 102 is charged at office or at public and private charging facilities. Therefore, the neural network 116 may have deduced that the user of the vehicle 102 may not have charging infrastructure/facility at home. Additionally, the neural network 116 may have learnt that the vehicle 102 may be used to commute to a tennis club on every Saturday. Therefore, based on the learnt vehicle usage pattern and charging pattern and a current day of week being “Friday”, the processing circuitry 110 may generate a recommended charging plan for charging the energy storage device 108. The recommended charging plan may be presented to the user by way of the HMI 220 of the vehicle 102. The recommended charging plan may include a recommendation “Hey! Energy may not be sufficient to commute to Tennis Club on Saturday, why don't you charge at office.”

It may be apparent to a person skilled in the art that FIGS. 6A and 6B are exemplary and does not limit the scope of the disclosure. In other embodiments, the processing circuitry 110 may be configured to generate different charging plans based on at least one of state of charge, cost of charge, location of charge, speed of charge, route to be traversed by the vehicle 102, or the like.

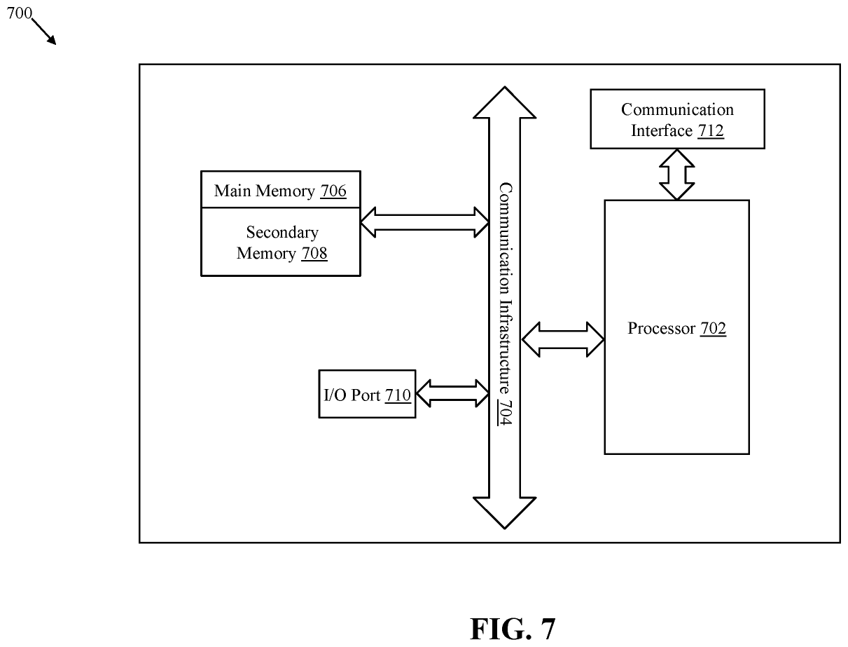

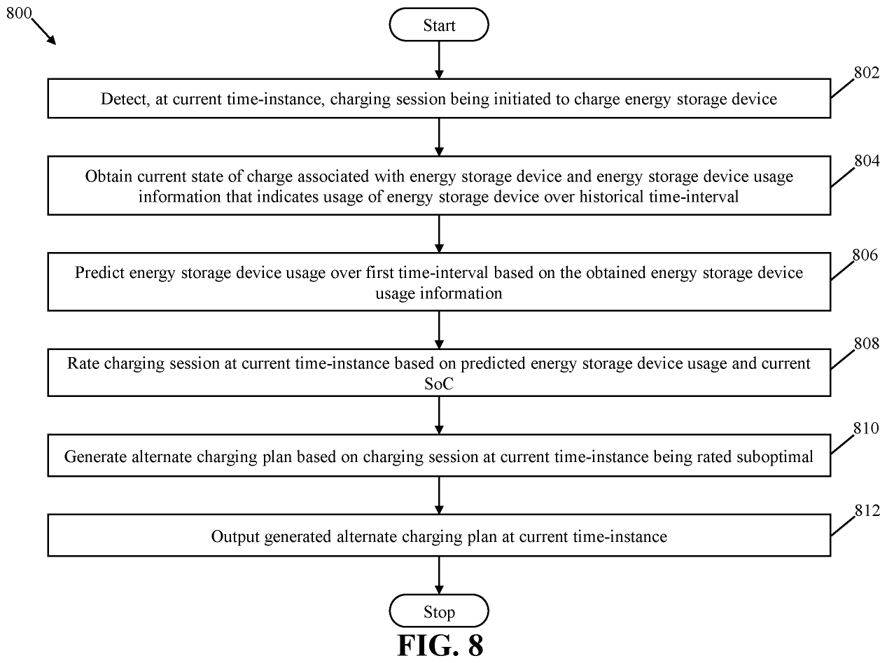

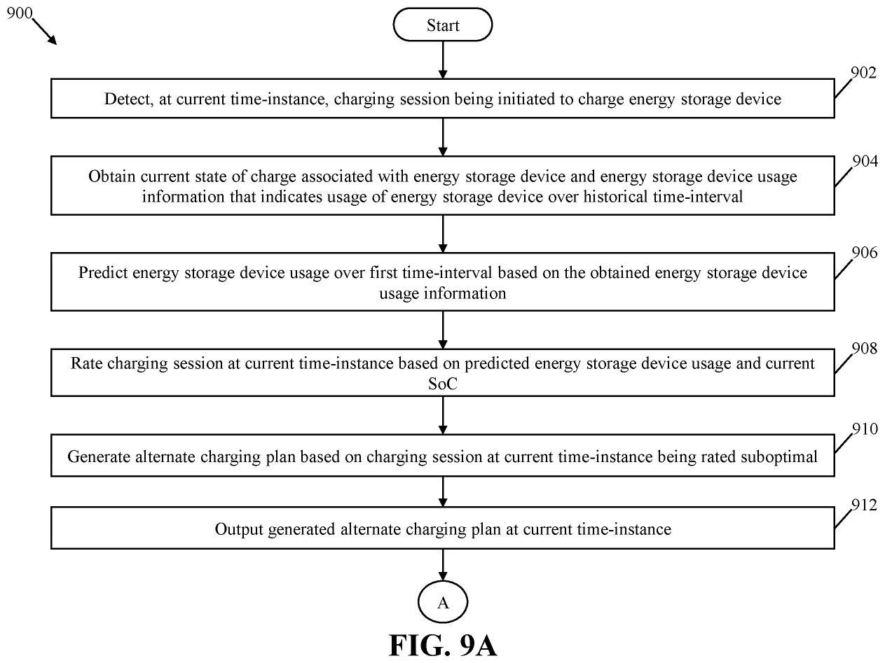

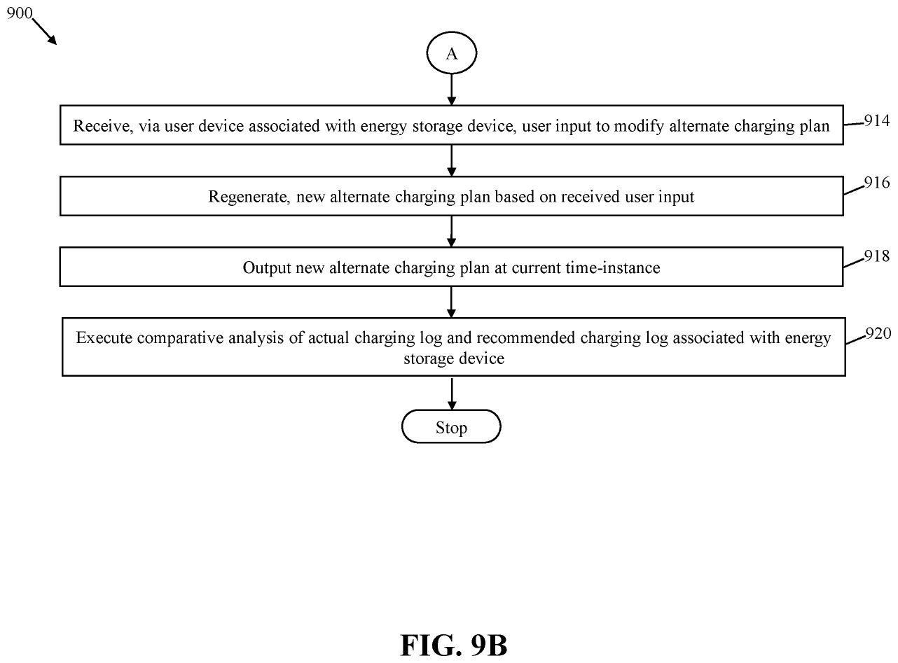

FIG. 7 is a block diagram that illustrates a system architecture of a computer system for implementation of the charging recommendation method, in accordance with an exemplary embodiment of the disclosure. Referring to FIG. 7, illustrated is the computer system 700. Some embodiments of the disclosure, or portions thereof, may be implemented as computer readable code on the computer system 700. In some examples, the control server 118 or the database server 104 of FIGS. 1A and 1B may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 8, 9A, 9B, and 9C. The computer system 700 may include a processor 702, a communication infrastructure 704, a main memory 706, a secondary memory 708, an input/output (I/O) port 710, and a communication interface 712.

The processor 702 that may be a special purpose or a general-purpose processing device. The processor 702 may be a single processor or multiple processors. The processor 702 may have one or more processor “cores.” Further, the processor 702 may be coupled to the communication infrastructure 704, such as a bus, a bridge, a message queue, the communication network 106, multi-core message-passing scheme, or the like. Examples of the main memory 706 may include RAM, ROM, and the like. The secondary memory 708 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In some embodiments, the secondary memory 708 may be a non-transitory computer readable recording media.

The I/O port 710 may include various input and output devices that are configured to communicate with the processor 702. Examples of the input devices may include a keyboard, a mouse, a joystick, a touchscreen, a microphone, and the like. Examples of the output devices may include a display screen, a speaker, headphones, and the like. The communication interface 712 may be configured to allow data to be transferred between the computer system 700 and various devices that are communicatively coupled to the computer system 700. Examples of the communication interface 712 may include a modem, a network interface, i.e., an Ethernet card, a communication port, and the like. Data transferred via the communication interface 712 may be signals, such as electronic, electromagnetic, optical, or other signals as will be apparent to a person skilled in the art. The signals may travel via a communications channel, such as the communication network 106, which may be configured to transmit the signals to the various devices that are communicatively coupled to the computer system 700. Examples of the communication channel may include a wired, wireless, and/or optical medium such as cable, fiber optics, a phone line, a cellular phone link, a radio frequency link, and the like. The main memory 706 and the secondary memory 708 may refer to non-transitory computer readable mediums that may provide data that enables the computer system 700 to implement the methods illustrated in FIGS. 8, 9A, 9B, and 9C.

FIG. 8 is a flowchart that illustrates the charging recommendation method, in accordance with an exemplary embodiment of the disclosure. Referring to FIG. 8, there is shown a flow chart 800 that illustrates exemplary operations 802, 804, 806, 808, 810, and 812 for providing smart charging recommendations for vehicles. At 802, the charging session being initiated at the current time-instance to charge the energy storage device 108 may be detected. The processing circuitry 110 may be configured to detect, at the current time-instance, the charging session being initiated to charge the energy storage device 108.

At 804, the current state of charge (SoC) associated with the energy storage device 108 of the vehicle 102 and the first vehicle usage information that indicates the usage of the vehicle 102 over the historical time-interval may be obtained. The processing circuitry 110 may be configured to obtain the current state of charge (SoC) associated with the energy storage device 108 of the vehicle 102 and the first vehicle usage information that may indicate the usage of the vehicle 102 over the historical time-interval. The historical time-interval may occur prior to the current time-instance.

At 806, the vehicle usage over the first time-interval may be predicted based on the obtained first vehicle usage information. The processing circuitry 110 may be configured to predict the vehicle usage over the first time-interval based on the obtained first vehicle usage information. The first time-interval occurs after the current time-instance.

At 808, the charging session at the current time-instance may be rated based on the predicted vehicle usage/energy storage device usage and the current SoC at the first time-instance. The processing circuitry 110 may be configured to rate the charging session at the current time-instance based on the predicted vehicle usage/energy storage device usage and the current SoC at the first time-instance.

At 810, the alternate charging plan may be generated based on the charging session at the current time-instance being rated suboptimal. The processing circuitry 110 may be configured to generate the alternate charging plan based on the charging session initiated at the current time-instance being rated suboptimal. The generated alternate charging plan may be rated optimal and accommodates the predicted vehicle usage.

At 812, the generated alternate charging plan may be outputted at the current time-instance. The processing circuitry 110 may be configured to output the generated alternate charging plan at the current time-instance. The generated alternate charging plan may be outputted via the user device 114 associated with the vehicle 102.

FIGS. 9A and 9B, collectively, represent a high-level flowchart that illustrates the charging recommendation method, in accordance with an exemplary embodiment of the disclosure. Referring to FIGS. 9A and 9B, there is shown a flow chart 900 that illustrates exemplary operations 902, 904, 906, 908, 910, 912, 914, 916, 918, and 920 for providing smart charging recommendations for vehicles.

At 902, the charging session being initiated at the current time-instance to charge the energy storage device 108 may be detected. The processing circuitry 110 may be configured to detect, at the current time-instance, the charging session being initiated to charge the energy storage device 108.

At 904, the current state of charge (SoC) associated with the energy storage device 108 of the vehicle 102 and the first vehicle usage information that indicates the usage of the vehicle 102 over the historical time-interval may be obtained. The processing circuitry 110 may be configured to obtain the current state of charge (SoC) associated with the energy storage device 108 of the vehicle 102 and the first vehicle usage information that may indicate the usage of the vehicle 102 over the historical time-interval. The historical time-interval may occur prior to the current time-instance.

At 906, the vehicle usage over the first time-interval may be predicted based on the obtained first vehicle usage information. The processing circuitry 110 may be configured to predict the vehicle usage over the first time-interval based on the obtained first vehicle usage information. The first time-interval occurs after the current time-instance.

At 908, the charging session at the current time-instance may be rated based on the predicted vehicle usage and the current SoC at the first time-instance. The processing circuitry 110 may be configured to rate the charging session at the current time-instance based on the predicted vehicle usage and the current SoC at the first time-instance.

At 910, the alternate charging plan may be generated based on the charging session at the current time-instance being rated suboptimal. The processing circuitry 110 may be configured to generate the alternate charging plan based on the charging session initiated at the current time-instance being rated suboptimal. The generated alternate charging plan may be rated optimal and accommodates the predicted vehicle usage.

At 912, the generated alternate charging plan may be outputted at the current time-instance. The processing circuitry 110 may be configured to output the generated alternate charging plan at the current time-instance. The generated alternate charging plan may be outputted via the user device 114 associated with the vehicle 102.

Referring to FIG. 9B, at 914, the user input to modify the alternate charging plan may be received via the user device 114 associated with the vehicle 102. The processing circuitry 110 may be configured to receive, via the user device 114 associated with the vehicle 102, the user input to modify the alternate charging plan.

At 916, the new alternate charging plan may be regenerated based on the received user input. The processing circuitry 110 may be configured to regenerate the new alternate charging plan based on the received user input.

At 918, the new alternate charging plan may be outputted at the current time-instance. The processing circuitry 110 may be configured to output the new alternate charging plan at the current time-instance. The new alternate charging plan may be outputted via the user device 114.

At 920, the comparative analysis of the actual charging log and the recommended charging log associated with the energy storage device 108 may be executed. The processing circuitry 110 may be configured to execute the comparative analysis of the actual charging log and the recommended charging log associated with the energy storage device 108. The comparative analysis may be presented to the user of the vehicle 102 via the user interface 112 of the user device 114.

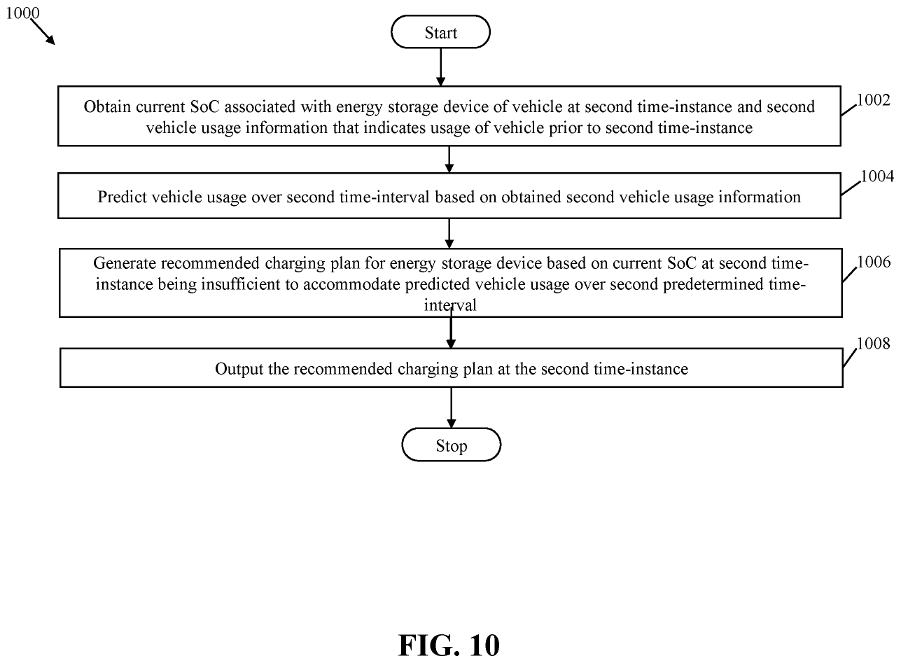

FIG. 10 is a flowchart that illustrates the charging recommendation method, in accordance with an exemplary embodiment of the disclosure. Referring to FIG. 10, there is shown a flow chart 1000 that illustrates exemplary operations 1002, 1004, 1006, and 1008 for providing smart charging recommendations for vehicles.

At 1002, the current state of charge (SoC) associated with the energy storage device 108 of the vehicle 102 at the second time-instance and the second vehicle usage information that indicates the usage of the vehicle 102 prior to the second time-instance may be obtained. The processing circuitry 110 may be configured to obtain the second current state of charge (SoC) associated with the energy storage device 108 of the vehicle 102 at the second time-instance and the second vehicle usage information that indicates the usage of the vehicle 102 prior to the second time-instance.

At 1004, the vehicle usage over the second time-interval may be predicted based on the obtained second vehicle usage information. The second time-interval occurs after the second time-instance. The processing circuitry 110 may be configured to predict the vehicle usage over the second time-interval based on the obtained second vehicle usage information.

At 1006, the recommended charging plan for the energy storage device 108 may be generated based on the current SoC at the second time-instance being insufficient to accommodate the predicted vehicle usage over the second time-interval. The processing circuitry 110 may be configured to generate the recommended charging plan for the energy storage device 108 based on the current SoC at the second time-instance being insufficient to accommodate the predicted vehicle usage over the second time-interval.

At 1008, the recommended charging plan at the second time-instance may be generated. The processing circuitry 110 may be configured to generate the recommended charging plan at the second time-instance. The recommended charging plan may be generated in a way to accommodate vehicle usage during the time-interval between the second time-instance and subsequent charging opportunity.

Various embodiments of the disclosure provide the processing circuitry 110 for implementing the charging recommendation method. The processing circuitry 110 may be configured to detect, at the current time-instance, the charging session being initiated to charge the energy storage device 108. The processing circuitry 110 may be further configured to obtain the current SoC at the first time-instance associated with the energy storage device 108 of the vehicle 102 and the first vehicle usage information that indicates the usage of the vehicle 102 over the historical time-interval. The historical time-interval occurs prior to the current time-instance. The processing circuitry 110 may be further configured to predict vehicle usage over the first time-interval based on the obtained first vehicle usage information. The first time-interval occurs after the current time-instance. The processing circuitry 110 may be further configured to rate the charging session initiated at the current time-instance based on the predicted vehicle usage and the current SoC at the first time-instance. The processing circuitry 110 may be further configured to generate the alternate charging plan based on the charging session at the current time-instance being rated suboptimal. The generated alternate charging plan may be rated optimal and accommodates the predicted vehicle usage. The processing circuitry 110 may be further configured to output the generated alternate charging plan at the current time-instance. The processing circuitry 110 may be further configured to obtain the current SoC at the second time-instance associated with the energy storage device 108 of the vehicle 102 at the second time-instance and the second vehicle usage information that indicates the usage of the vehicle 102 prior to the second time-instance. The processing circuitry 110 may be further configured to predict vehicle usage over the second time-interval based on the obtained second vehicle usage information. The second time-interval occurs after the second time-instance. The processing circuitry 110 may be further configured to generate the recommended charging plan for the energy storage device 108 based on the current SoC at the second time-instance being insufficient to accommodate the predicted vehicle usage over the second time-interval. The processing circuitry 110 may be further configured to output the recommended charging plan at the second time-instance.

Various embodiments of the disclosure provide a non-transitory computer readable medium having stored thereon, computer executable instructions, which when executed by a computer, cause the computer to execute one or more operations for implementing the charging recommendation method. The one or more operations include detecting, by the processing circuitry 110, at the current time-instance, the charging session being initiated to charge the energy storage device 108. The one or more operations further include obtaining, by the processing circuitry 110, the first current state of charge (SoC) associated with the energy storage device 108 and energy storage device usage information that indicates the usage of the energy storage device 108 over the historical time-interval. The historical time-interval occurs prior to the current time-instance. The one or more operations further include predicting, by the processing circuitry 110, the energy storage device usage over the time-interval based on the obtained energy storage device usage information. The time-interval occurs after the current time-instance. The one or more operations further include rating, by the processing circuitry 110, the charging session initiated at the current time-instance based on the predicted energy storage device usage and the current SoC at the first time-instance. The one or more operations further include generating, by the processing circuitry 110, the alternate charging plan based on the charging session at the current time-instance being rated suboptimal. The generated alternate charging plan may be rated optimal and accommodates the predicted energy storage device usage. The one or more operations further include outputting, by the processing circuitry 110, the generated alternate charging plan at the current time-instance. The one or more operations further include obtaining the current SoC at the second time-instance associated with the energy storage device 108 of the vehicle 102 at the second time-instance and the second vehicle usage information that indicates the usage of the vehicle 102 prior to the second time-instance. The one or more operations further include predicting vehicle usage over the second time-interval based on the obtained second vehicle usage information. The second time-interval occurs after the second time-instance. The one or more operations further include generating the recommended charging plan for the energy storage device 108 based on the current SoC at the second time-instance being insufficient to accommodate the predicted vehicle usage over the second time-interval. The one or more operations further include outputting the recommended charging plan at the second time-instance.

The disclosed embodiments encompass numerous advantages. Exemplary advantages of the disclosed methods include, but are not limited to, generating alternate charging plans for charging vehicles. The disclosed vehicles, methods, and systems are configured to detect a charging session that may be suboptimal and may either be insufficient, cost-intensive, or may negatively affect health of corresponding vehicle. Further, the disclosed vehicles, methods, and system may predict subsequent vehicle usage and may generate an alternate charging plan that may be optimal and may accommodate the predicted vehicle usage. Such generation of alternate charging plan that may convenient to the user as well as optimal in terms of electric charge availability, cost, time, location, or the like may alleviate range anxiety of the user of the vehicle regarding having enough electric charge availability. Further, the disclosed vehicles, methods, and systems also enable detection of unpredicted vehicle usage and electric charge consumption and hence may generate a new charging plan that may compensate for the unpredicted vehicle usage and electric charge consumption. The disclosed vehicles, methods, and systems also allow the user of the vehicle to modify the alternate charging plan as per his/her convenience. Hence, the alternate charging plan may ensure that the vehicle does not have insufficient charge and does not run out of charge. Further, the disclosed vehicles, methods, and systems may periodically detect the current SoC of the vehicle 102 and may predict subsequent vehicle usage over the second time-interval. Further, the vehicles, methods, and systems may generate the recommended charging plan based on the current SoC at the second time-instance and predicted vehicle usage. Therefore, the vehicles, systems, and methods disclosed herein prevents vehicles from getting stranded. Further, the vehicles, systems, and methods may be implemented by way of existing technology and are cost-efficient. Also, vehicles disclosed herein eliminate a necessity of connectivity with the control server 118 for generating the alternate charging plan and/or the recommended charging plan. Thus, the vehicles, methods, and systems disclosed herein are robust. The vehicles, methods, and systems disclosed herein require minimal or no user-intervention for generating the alternate plan and hence are time-efficient in generating the alternate charging plan. Also, the alternate charging plan and the recommended charging plan are generated in real-time or near real-time and hence significantly alleviates range anxiety of users of vehicles.

The vehicles, methods, and systems disclosed herein allow charging of the energy storage device 108 in accordance with one or more rules that may optimize the SoH of the energy storage device 108. Further, charging the energy storage device 108 in accordance with the one or more rules that may optimize the SoH of the energy storage device 108 and may increase or positively effect remaining useful life of one or more components of the vehicles. Further, various areas of application of the disclosed methods may include automobile industry, aviation industry, electronic items manufacturing industry, or any other field that may require charging a battery, battery pack, energy storage device, or the like.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the scope of the disclosed subject matter.

Techniques consistent with the disclosure provide, among other features, the vehicle 102 and charging recommendation methods for charging the energy storage device 108 of the vehicle 102. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A vehicle, comprising:
an energy storage device configured to power the vehicle; and
processing circuitry configured to:
detect, at a current time-instance, a charging session being initiated to charge the energy storage device;
obtain a current state of charge associated with the energy storage device of the vehicle and first vehicle usage information that indicates a usage of the vehicle over a historical time-interval, wherein the historical time-interval occurs prior to the current time-instance;
predict vehicle usage over a first time-interval based on the obtained first vehicle usage information, wherein the time-interval occurs after the current time-instance;
rate the charging session at the current time-instance based on the predicted vehicle usage and the current state of charge;
generate an alternate charging plan based on the charging session at the current time-instance being rated suboptimal, wherein the generated alternate charging plan is rated optimal and accommodates the predicted vehicle usage; and
output the generated alternate charging plan at the current time-instance.

2. The vehicle of claim 1, wherein the vehicle usage over the first time-interval is predicted by a neural network that has learnt a vehicle usage pattern for the vehicle based on time-series of vehicle usage data of the vehicle.

3. The vehicle of claim 1, wherein the processing circuitry is further configured to execute a comparative analysis of an actual charging log and a recommended charging log associated with the vehicle, wherein the actual charging log indicates an actual charging history of the vehicle, and wherein the recommended charging log indicates a charging history in accordance with the alternate charging plan.

4. The vehicle of claim 3, wherein the actual charging log is same as the recommended charging log.

5. The vehicle of claim 3, wherein the actual charging log is different from the recommended charging log.

6. The vehicle of claim 1, wherein the alternate charging plan includes at least one of an alternate location to charge, an alternate charging speed, an alternate cost of charging, an alternate time-instance to charge, and an alternate state of charge of the energy storage device that is different from the current state of charge to initiate an alternate charging session of the energy storage device.

7. The vehicle of claim 1, wherein the processing circuitry is further configured to:
receive, via a user device associated with the vehicle, a user input to modify the alternate charging plan;
regenerate a new alternate charging plan based on the received user input; and
output the new alternate charging plan at the current time-instance.

8. The vehicle of claim 1, wherein the processing circuitry is configured to rate the current charging session based on at least one of one or more driving parameters associated with the predicted vehicle usage of the vehicle, a cost of charging during the current charging session, a charging time duration required for the current charging session, and an impact of the current charging session on a state of health of the energy storage device.

9. The vehicle of claim 1, wherein the energy storage device is one of a battery, a supercapacitor, and a battery pack.

10. The vehicle of claim 1, wherein the predicted vehicle usage information includes at least one of one or more routes to be traveled by the vehicle, a time of travel corresponding to each route to be traveled by the vehicle, one or more driving parameters, a count of drivers of the vehicle, a count of riders of the vehicle, and auxiliary power consumption by one or more vehicle accessories during one or more trips by the vehicle, over the time-interval.

11. The vehicle of claim 10, wherein the one or more driving parameters include a velocity profile, a braking profile, an acceleration profile, and a mode of operating the vehicle over the first time-interval.

12. The vehicle of claim 1, wherein the processing circuitry is further configured to:
obtain a current state of charge associated with the energy storage device of the vehicle at a second time-instance and second vehicle usage information that indicates a usage of the vehicle prior to the second time-instance;
predict vehicle usage over a second time-interval based on the obtained second vehicle usage information, wherein the second time-interval occurs after the second time-instance;
generate a recommended charging plan for the energy storage device based on the current state of charge at the second time-instance being insufficient to accommodate the predicted vehicle usage over the second time-interval; and
output the recommended charging plan at the second time-instance.

13. The vehicle of claim 12, wherein the recommended charging plan includes one of a recommended location to charge the energy storage device, a recommended charging duration to charge the energy storage device, a recommended state of charge to be attained by charging the energy storage device, a route to be traversed to reach the recommended charging location to charge the energy storage device, and a recommended auxiliary power consumption of the vehicle while traversing the route to reach the recommended charging location.

14. A charging recommendation method, comprising:
detecting, by processing circuitry, at a current time-instance, a charging session being initiated to charge an energy storage device;
obtaining, by the processing circuitry, a current state of charge associated with the energy storage device and energy storage device usage information that indicates a usage of the energy storage device over a historical time-interval, wherein the historical time-interval occurs prior to the current time-instance;
predicting, by the processing circuitry, energy storage device usage over a time-interval based on the obtained energy storage device usage information, wherein the time-interval occurs after the current time-instance;
rating, by the processing circuitry, the charging session at the current time-instance based on the predicted energy storage device usage and the current state of charge;
generating, by the processing circuitry, an alternate charging plan based on the charging session at the current time-instance being rated suboptimal, wherein the generated alternate charging plan is rated optimal and accommodates the predicted energy storage device usage; and
outputting, by the processing circuitry, the generated alternate charging plan at the current time-instance.

15. The method of claim 14, further comprising executing, by the processing circuitry, a comparative analysis of an actual charging log and a recommended charging log associated with the energy storage device, wherein the actual charging log indicates an actual charging history of the energy storage device, and wherein the recommended charging log indicates a charging history in accordance with the alternate charging plan.

16. The method of claim 15, wherein the actual charging log is same as the recommended charging log.

17. The method of claim 15, wherein the actual charging log is different from the recommended charging log.

18. The method of claim 14, wherein the alternate charging plan includes at least one of an alternate location to charge, an alternate charging speed, an alternate cost of charging, an alternate time-instance to charge, and an alternate state of charge of the energy storage device that is different from the current state of charge to initiate an alternate charging session, of the energy storage device.

19. The method of claim 14, wherein the energy storage device is a one of a battery, a supercapacitor, and a battery pack of a vehicle.

20. The method of claim 14, wherein the current charging session is rated based on at least one of one or more usage parameters associated with the predicted energy storage device usage, a cost of charging during the current charging session, a charging time duration required for the current charging session, and an impact of the current charging session on a state of health of the energy storage device.
